(19) United States
(12) Patent Application Publication
(10) Pub. No.: US 2026/0030800 A1
(43) Pub. Date: Jan. 29, 2026

(54) IMAGE PROCESSING METHOD, IMAGE PROCESSING DEVICE, ELECTRONIC DEVICE, AND COMPUTER-READABLE STORAGE MEDIUM

(71) Applicant: UBTECH ROBOTICS CORP LTD, Shenzhen (CN)

(72) Inventors: Yusheng Zeng, Shenzhen (CN); Pei Dong, Shenzhen (CN)

(21) Appl. No.: 19/254,057

(22) Filed: Jun. 30, 2025

(30) Foreign Application Priority Data
Jul. 26, 2024 (CN) 202411017403.7

(51) Int. Cl. G06T 11/00; G06T 5/60; G06T 5/70; G06T 7/70; G06V 20/00; G06V 40/16; G06V 40/18

(52) U.S. Cl. CPC G06T 11/001; G06T 5/60; G06T 5/70; G06T 7/70; G06V 20/35; G06V 40/171; G06V 40/174; G06V 40/18; G06T 2207/10016; G06T 2207/20081; G06T 2207/20084; G06T 2207/30201

(57) ABSTRACT

An image processing method, an image processing device, an electronic device, and a computer-readable storage medium are provided. The image processing method includes: recognizing and analyzing an original image to obtain theme elements of the original image and facial attribute information of a target object in the original image, and determining text prompt information based on a predetermined target style, the theme elements and the facial attribute information; performing pose estimation on the original image to obtain pose information of the target object in the original image; performing noise adding processing on the original image to obtain a target noise image; generating image noise based on the target noise image, the text prompt information, the facial attribute information, and the pose information; and generating a target image of the predetermined target style based on the image noise and the target noise image.

### CROSS REFERENCE TO RELATED APPLICATIONS

The present disclosure claims foreign priority to Chinese Patent Application No. 202411017403.7, titled “IMAGE PROCESSING METHOD, IMAGE PROCESSING DEVICE, ELECTRONIC DEVICE, AND COMPUTER-READABLE STORAGE MEDIUM”, filed on Jul. 26, 2024 in China National Intellectual Property Administration, and the entire contents of which are hereby incorporated by reference.

### TECHNICAL FIELD

The present disclosure relates to a technical field of artificial intelligence (AI), and in particular to an image processing method, an image processing device, an electronic device, and a computer-readable storage medium.

### BACKGROUND

Stylized images obtained by stylizing original images based on a Pix2pix framework (an image-to-image translation framework) or a cycle generative adversarial network (CycleGAN) have a series of problems such as single image style, unrealistic local distortion, and poor generalization.

In related art, in order to solve the above problems, image generation methods dominated by diffusion models or stable diffusion models have become mainstream. However, the stylized images generated by the image generation methods have a problem of poor relevance with the original images.

### SUMMARY

Embodiments of the present disclosure provide an image processing method, an image processing device, an electronic device, and a computer-readable storage medium, which accurately convert an original image into a target image of a predetermined target style and improve relevance of the target image to the original image.

In one embodiment, the present disclosure provides the image processing method. The image processing method comprises steps:
recognizing and analyzing an original image to obtain theme elements of the original image and facial attribute information of a target object in the original image, and determining text prompt information based on a predetermined target style, the theme elements and the facial attribute information;
performing pose estimation on the original image to obtain pose information of the target object in the original image;
performing noise adding processing on the original image to obtain a target noise image;
generating image noise based on the target noise image, the text prompt information, the facial attribute information of the target object in the original image, and the pose information of the target object in the original image; and
generating a target image of the predetermined target style based on the image noise and the target noise image.

In one embodiment, the present disclosure provides the image processing device. The image processing device comprises a text prompt acquisition module, a pose estimation module, a noise adding module, a noise generation module, and an image generation module. The text prompt acquisition module is configured to recognize and analyze an original image to obtain theme elements of the original image and facial attribute information of a target object in the original image. The text prompt acquisition module is further configured to determine text prompt information based on a predetermined target style, the theme elements and the facial attribute information. The pose estimation module is configured to perform pose estimation on the original image to obtain pose information of the target object in the original image. The noise adding module is configured to perform noise adding processing on the original image to obtain a target noise image. The noise generation module is configured to generate image noise based on the target noise image, the text prompt information, the facial attribute information of the target object in the original image, and the pose information of the target object in the original image. The image generation module is configured to generate a target image of the predetermined target style based on the image noise and the target noise image.

In one optional embodiment, the text prompt acquisition module is further configured to: perform scene understanding analysis on the original image based on a pre-trained visual language model to obtain the theme elements of the original image, recognize the target object in the original image to obtain a face image of the target object, and perform feature extraction on the face image based on a pre-trained multi-attribute task network to obtain the facial attribute information of the target object.

In one optional embodiment, the text prompt acquisition module is further configured to: encode the original image based on an image encoder in the pre-trained visual language model to obtain an image representation vector, obtain image description prompt information, encode the image description prompt information based on a text encoder in the pre-trained visual language model to obtain a prompt information feature vector, perform matching processing on the image representation vector and the prompt information feature vector to obtain a target feature vector, and decode the target feature vector based on a text decoder in the pre-trained visual language model to obtain the theme elements of the original image.

In one optional embodiment, the text prompt acquisition module is further configured to: perform feature extraction on the face image based on the pre-trained multi-attribute task network to obtain at least one of object attribute information, wear information, an expression score, an aesthetic score, and facial key points of the target object, and generate the facial attribute information based on at least one of the object attribute information, the wear information, the expression score, the aesthetic score, and the facial key points of the target object.

In one optional embodiment, the text prompt acquisition module is further configured to determine eye state information and lip state information based on the facial key points. When the expression score is greater than a predetermined first threshold, the text prompt acquisition module is further configured to obtain an expression prompt and generate the facial attribute information based on at least one of the object attribute information, the wear information, the expression prompt, the eye state information, and the lip state information. When the aesthetic score is greater than a predetermined second threshold, the text prompt acquisition module is further configured to obtain an aesthetic prompt, and generating the facial attribute information based on at least one of the object attribute information, the wear information, the aesthetic prompt, the eye state information, and the lip state information.

In one optional embodiment, the noise generation module is further configured to: perform feature extraction on the predetermined target style, the theme elements, and the facial attribute information to obtain text feature, and performing feature extraction on the facial attribute information in the original image to obtain an image feature; perform normalization processing on the image feature to obtain a target image feature; perform feature extraction on the pose information to obtain a pose feature; and generate the image noise based on the target noise image, the text feature, the target image feature, and the pose feature.

In one optional embodiment, the noise generation module is further configured to: perform self-attention processing based on the target noise image and the text feature to obtain a first attention feature; perform self-attention processing based on the target noise image and the target image feature to obtain a second attention feature; and fuse the first attention feature, the second attention feature, and the pose feature to obtain the image noise corresponding to the target noise image.

In one optional embodiment, the noise generation module is further configured to: fuse the first attention feature, the second attention feature, and the pose feature to obtain target noise; obtain weight parameters corresponding to the predetermined target style; and determine the image noise corresponding to the target noise image based on the target noise and the weight parameters.

In one optional embodiment, the image generation module is further configured to denoise the target noise image based on the image noise to obtain a (T−1)^{th} restored image, where T is an integer greater than 1. The image generation module is further configured to generate a t^{th} image noise corresponding to a t^{th} restored image based on the t^{t} restored image, the text prompt information, the facial attribute information in the original image, and the pose information. The image generation module is further configured to denoise the t^{th} restored image based on the t^{th} image noise to obtain a (t−1)^{th} restored image; where t=T−1, T−2, . . . 2. The image generation module is further configured to generate a first image noise corresponding to the first restored image based on the first restored image, the text prompt information, the facial attribute information, and the pose information, and denoising the first restored image based on the first image noise to obtain the target image of the predetermined target style.

In one optional embodiment, the image processing device further comprises a video processing module. The video processing module is configured to: obtain video frame images of a video to be processed; determine target text prompt information of each of the video frame images based on the predetermined target style and each of the video frame images; perform face recognition on the video frame images to obtain target face images and perform pose estimation on the video frame images to obtain target pose information of a target object in the video frame images; perform noise adding processing on the video frame images to obtain noise video frame images, generate video frame noise based on the noise video frame images, the target text prompt information, the target face images, and the target pose information; generate the target video frame images of the predetermined target style based on the video frame noise and the noise video frame images; and arrange the target video frame images in time order to obtain a target video of the predetermined target style.

One embodiment of the present disclosure further provides the electronic device. The electronic device comprises a memory and a processor. The memory is configured to store computer-executable instructions or a computer program. The processor is configured to execute the computer-executable instructions or the computer program stored in the memory to implement the image processing method of the embodiments of the present disclosure.

One embodiment of the present disclosure further provides the computer-readable storage medium. The computer-readable storage medium comprises computer-executable instructions stored therein or a computer program stored therein. The computer-executable instructions or the computer program is executed by a processor to implement the image processing method according to the embodiments of the present disclosure.

In a process of image stylization, the noise adding processing is performed on the original image to obtain the target noise image; the image noise is generated based on the target noise image, the text prompt information, the facial attribute information of the target object in the original image, and the pose information of the target object in the original image, and the target image of the predetermined target style is generated based on the image noise and the target noise image. The text prompt information is determined based on the predetermined target style, the theme elements, and the facial attribute information of the target object in the original image. Compared to a method of generating images by a pre-trained diffusion model or a pre-trained stable diffusion model in the related art, the embodiments of the present disclosure integrate the text prompt information, the facial attribute information, and the pose information related to the original image, so that the target image is similar to the original image, and the original image is accurately converted into the target image of the predetermined target style, thereby improving the relevance of the target image to the original image. In addition, compared to the related art of manually inputting a large amount of text prompts, in the embodiments of the present disclosure, the text prompt information is determined by the theme elements identified from the original image, the facial attribute information obtained from the original image, and the predetermined target style. Namely, the present disclosure omits a need for manually inputting text prompts, thereby improving the accuracy and efficiency of image stylization processing.

### BRIEF DESCRIPTION OF DRAWINGS

FIG. 1 is a schematic diagram of an image processing system according to one embodiment of the present disclosure.

FIG. 2 is a block diagram of an electronic device according to one embodiment of the present disclosure.

FIG. 3 is a flow chart of an image processing method according to one embodiment of the present disclosure.

FIG. 4 is a flow chart of the step S101 of the image processing method according to one embodiment of the present disclosure.

FIG. 5 is another flow chart of the step S104 of the image processing method according to one embodiment of the present disclosure.

FIG. 6 is another flow chart of the step S105 of the image processing method according to one embodiment of the present disclosure.

FIG. 7 is another flow chart of the image processing method according to one embodiment of the present disclosure.

FIG. 8 is another flow chart of the image processing method according to one embodiment of the present disclosure.

FIG. 9 is a schematic diagram of the image processing method according to one embodiment of the present disclosure.

FIG. 10 is a flow chart of an image processing process of a pre-trained diffusion model according to one embodiment of the present disclosure.

FIG. 11 is a flow chart of an image processing process of a pre-trained stable diffusion model according to one embodiment of the present disclosure.

FIG. 12 is a schematic diagram of a pre-trained multi-attribute task network according to one embodiment of the present disclosure.

FIG. 13 is a schematic diagram of a cross-modal network with decoupled vision and text according to one embodiment of the present disclosure.

FIG. 14 is a schematic diagram of target images obtained under different stylized weight parameters according to one embodiment of the present disclosure.

FIG. 15 is a schematic diagram of a pose control branch network according to one embodiment of the present disclosure.

FIG. 16 is a schematic diagram of a cross-modal network combining vision, text and pose according to one embodiment of the present disclosure.

FIG. 17 is a schematic diagram of a LoRa branch network according to one embodiment of the present disclosure.

### DETAILED DESCRIPTION

In order to make the objectives, technical solutions, and characteristics of the present disclosure clear, the present disclosure is described in detail with reference to the accompanying drawings, and the described embodiments are not considered as limitations to the present disclosure, and all other embodiments obtained by those skilled in the art without creative efforts shall fall within the protection scope of the present disclosure.

In the description of the present disclosure, reference is made to “some embodiments”, which describe a subset of all possible embodiments, but it is to be understood that “some embodiments” may be the same subset or different subsets of all possible embodiments and may be combined with each other without conflict.

In the description of the present disclosure, the terms “first”, “second”, and “third” involved are for distinguishing similar objects, and do not represent a specific order for the similar objects. It is understood that the terms “first”, “second”, and “third” may be interchanged with a particular order or sequence when allowed, so that the embodiments of the present disclosure described herein can be implemented in an order other than illustrated or described herein.

In the embodiments of the present disclosure, the term “module” or “unit” refers to a computer program or a part of a computer program having a predetermined function, and works with other related parts to implement a predetermined target, and may be implemented completely or partially by using software, hardware (for example, a processing circuit or a memory), or a combination thereof. Similarly, a processor (or a plurality of processors or memories) may be configured to implement one or more modules or units. In addition, each module or each unit may be a part of an overall module or an overall unit having functions of each module or each unit.

Unless otherwise defined, all technical terms and scientific terms used in the embodiments of the present disclosure have the same meaning as commonly understood by those skilled in the art. Terms used in the embodiments of the present disclosure are merely intended to describe objectives of the embodiments of the present disclosure, and are not intended to limit the present disclosure.

In the embodiments of the present disclosure, when data collection processing is applied to the instance application, it should strictly follow requirements of related laws and regulations to obtain the informed consent or separate consent of the personal information subject, and subsequent data use and processing should be carried out within the scope of authorization of the related laws and regulations and the personal information subject.

Before further describing the embodiments of the present disclosure in detail, the terms involved in the embodiments of the present disclosure are explained. The terms involved in the embodiments of the present disclosure are subject to the following interpretations.

1) The term “image stylization” refers to a process of applying a specific image style to an original image through deep learning technology while keeping contents of the original image unchanged. The image stylization generally involves style transfer and style fusion of the original image to generate a target image with unique style and creativity.

2) The term “diffusion model” refers to a deep learning model based on a probabilistic process, which is configured to generate a final output image based on given initial conditions (such as a noise image). The diffusion model gradually builds pixels of the final output image by simulating a process of material diffusion to generate a final output image with high details and rich colors.

3) The term “stable diffusion model” refers to an image generation model based on the deep learning technology. The stable diffusion model is able to generate a high-quality and high-resolution image based on text prompts. The stable diffusion model further has powerful image stylization capabilities and is able to generate a target image with unique style and creativity based on the text prompts entered by a user. The stable diffusion model comprises two main parts, which are respectively an encoder and a denoising network (denoising U-Net).

4) The term “latent space” refers to a concept in the deep learning model that describes a mapping relationship between input data and output data. In deep learning, the latent space commonly refers to a hidden space, which shows a connection relationship between neurons inside the deep learning mode. For example, in the stable diffusion model, the encoder of the stable diffusion model is configured to convert input text prompts into a vector representation in the latent space. The vector representation contains detailed information about the content of the image, such as colors, texture, shape, etc.

5) The term “prompt” refers to an input text or an input instruction configured to guide the deep learning model to perform a specific task. The prompt helps the deep learning model better understand the specific task and generate task-related input data, thereby improving accuracy and efficiency of the deep learning model. For example, in an artificial intelligence (AI) large model, the prompt is mainly configured to prompt the AI large model with context of input information and parameter information of an input model.

6) The term “scene understanding analysis” refers to a technology in a field of computer vision and is configured to identify and understand scenes and elements in images. The scene understanding analysis helps a computer system better understand and interpret image content, thus playing an important role in various application scenarios.

7) The term “theme elements” refers to representative elements in an image that reflect a theme of the image. In tasks such as image stylization, image recognition, and image annotation, the identification and analysis of the theme elements are very important.

8) The term “facial recognition” refers to a computer vision technology configured to identify and locate facial features in an image or a video. The facial recognition is realized by analyzing and identifying the facial features, such as face detection, face alignment, feature extraction, etc.

9) The term “pose estimation” refers to a technology in the field of computer vision that is configured to predict the pose and movement of a human body and/or an object. The pose estimation is realized by analyzing the body language, pose and movement of the human body and/or the object in an image or a video.

10) The term “noise adding” refers to a process of adding noise to data such as an image or an audio. The noise comprises the Gaussian noise, etc. In an image processing process of the stable diffusion model, the noise adding processing is also called a diffusion process. In the diffusion process, the stable diffusion model gradually introduces the noise to the original image, and gradually blurs the original image until the original image enters a random noise state.

11) The term “denoising” refers to a process of removing the noise from the data such as the image or the audio. In the image processing process of the stable diffusion model, the denoising processing refers to an inverse diffusion process of the stable diffusion model. According to the vector representation of the latent space output by the encoder, the denoising processing gradually reduces the noise, so that the noise image is restored into a clear image.

12) The term “self-attention processing” refers to a deep learning technology configured to calculate a degree of influence of each of the theme elements in the input data on other theme elements. The self-attention processing is realized by introducing a self-attention mechanism in a neural network, thereby improving the ability of the deep learning model to understand the input data and improving the generation ability.

In order to better understand the image processing method provided in the embodiments of the present disclosure, the image processing method configured to generate a target image with a predetermined target style in the related art and shortcomings thereof are first described.

When stylizing character images, generated stylized images based on a Pix2pix framework (an image-to-image translation framework based on conditional generative adversarial networks (CGANs)) or a cycle generative adversarial network (CycleGAN) have a series of problems such as single image style, unrealistic local distortion, and poor generalization. With the rise of diffusion models, image generation methods based on the diffusion models have become mainstream. With the combination of text feature and the diffusion models, images generated via the text feature make generated images more flexible and diverse. However, directly generating the images using the diffusion models takes too long. The stable diffusion models cleverly optimize the problem of long image generation time by generating the latent space. However, the images generated by the stable diffusion model are difficult to associate with the original images, and a large number of prompts need to be manually input to make the generated images approach an ideal generation effect. Therefore, the stylized images generated by the image generation methods have poor relevance with the original images, and the generation of the stylized images requires manually inputting of the prompts, which is inconvenient to use and has low efficiency in image stylization.

In view of the problems in the related art, embodiments of the present disclosure provide an image processing method, an image processing device, an electronic device, and a computer-readable storage medium, which accurately convert an original image into a target image of a predetermined target style and improve relevance of the target image to the original image.

In the image processing method of the present disclosure, the original image is recognized and analyzed first to obtain theme elements of the original image and facial attribute information of a target object in the original image; text prompt information is determined based on a predetermined target style, the theme elements, and the facial attribute information; then pose estimation is performed on the original image to obtain pose information of the target object in the original image; noise adding processing is performed on the original image to obtain target noise image; image noise are generated based on the target noise image, the text prompt information, the facial attribute information of the target object in the original image, and the pose information of the target object in the original image; and the target image of the predetermined target style is finally generated based on the image noise and the target noise image.

An example application of the image processing device according to one embodiment of the present disclosure is described as follows. The image processing device in the embodiment of the present disclosure is an electronic device configured to implement the image processing method. The electronic device in the embodiment of the present disclosure is a terminal, such as a laptop, a tablet, a desktop computer, a set-top box, a smartphone, a smart speaker, a smart watch, a smart television, or a vehicle-mounted terminal. Alternatively, the electronic device may be a server. The server is an independent physical server, a server cluster composed of a plurality of first physical servers, or a distributed system composed of a plurality of second physical servers. Alternatively, the server is a cloud server providing basic cloud computing services such as a cloud service, a cloud database, cloud computing, cloud function, cloud storage, a network service, cloud communication, a middleware service, a domain name service, a security service, a content delivery network (CDN), big data, and an AI platform. The terminal and the server are directly or indirectly connected in a wired communication manner or a wireless communication manner, which is not limited thereto. The present disclosure takes an example that the image processing device is the server or the terminal for further illustration.

FIG. 1 is a schematic diagram of an image processing system according to one embodiment of the present disclosure. To implement stylization processing on the original image, an image processing application is provided. For instance, the image processing application is an application dedicated to image processing, or a functional module in another application (e.g., an image processing module in an image collection application). The image processing system 100 in the embodiment of the present disclosure at least includes a terminal 400, a network 300, and a server 200. The server 200 is the server of the image processing application. The server 200 is served as the image processing device of the present disclosure. That is, the image processing method in the embodiments of the present disclosure is implemented by the server 200. The terminal 400 is connected to the server 200 through the network 300. The network 300 may be a wide area network, a local area network, or a combination thereof.

As shown in FIG. 1, a user may perform an interactive operation at a client of the image processing application through the terminal 400. The interactive operation may be an operation of inputting the original image, an operation of inputting a predetermined target style, an operation of clicking to start to generate the target image, etc. After receiving the interactive operation of the user, the client encapsulates the original image into an image processing request through the terminal and sends the image processing request to the server 200 through the network 300. After receiving the image processing request, the server 200 recognizes and analyzes the original image in response to the image processing request, so as to obtain the theme elements of the original image and the facial attribute information of the target object in the original image. Then, the server 200 determines the text prompt information based on the predetermined target style, the theme elements, and the facial attribute information. The server 200 further performs pose estimation on the original image to obtain the pose information of the target object in the original image. Further, the server 200 performs the noise adding processing on the original image to obtain the target noise image and generates the image noise based on the target noise image, the text prompt information, the facial attribute information of the target object in the original image, and the pose information of the target object in the original image. Then, the server 200 generates the target image of the predetermined target style based on the image noise and the target noise image. After generating the target image, the server 200 further sends the target image to the terminal 400 to display the target image to the user.

In some embodiments, the image processing method of the embodiments of the present disclosure is executed by the terminal 400 itself. That is, after receiving the interactive operation of the user, the terminal 400 recognizes and analyzes the original image in response to the image processing request, so as to obtain the theme elements of the original image and the facial attribute information of the target object in the original image. Then, the terminal 400 determines the text prompt information based on the predetermined target style, the theme elements, and the facial attribute information. The server 200 further performs pose estimation on the original image to obtain the pose information of the target object in the original image. Further, the terminal 400 performs the noise adding processing on the original image to obtain the target noise image and generates the image noise based on the target noise image, the text prompt information, the facial attribute information of the target object in the original image, and the pose information of the target object in the original image. Then, the terminal 400 generates the target image of the predetermined target style based on the image noise and the target noise image. After generating the target image, the target image is displayed on an interface of the client of the terminal 400.

The image processing method in the embodiments of the present disclosure is allowed to be implemented based on the cloud platform and through the cloud technology. For instance, the server 200 is the cloud server, and the original image is recognized and analyzed by the cloud server to obtain the theme elements of the original image and the facial attribute information of the target object in the original image. Then, the text prompt information is determined by the cloud server based on the predetermined target style, the theme elements, and the facial attribute information. The pose estimation is performed on the original image by the cloud server to obtain the pose information of the target object in the original image. The noise adding processing is performed on the original image by the cloud server to obtain the target noise image. The image noise is generated by the cloud server based on the target noise image, the text prompt information, the facial attribute information of the target object in the original image, and the pose information of the target object in the original image. Finally, the target image of the predetermined target style is generated by the cloud server based on the image noise and the target noise image.

It should be noted that the cloud technology refers to a hosting technology that unifies hardware, software, network, and other resources in the wide area network or the local area network to realize data computing, data storage, data processing and data sharing. The cloud technology is a general term for network technology, information technology, integration technology, management platform technology, application technology, etc. based on a cloud computing business model. The cloud technology forms a resource pool that is used on demand and is flexible and convenient. The cloud computing technology forms an important support for the cloud technology. Backend services of a technical network system require a large amount of computing and storage resources, such as video websites, picture websites and more portal websites. With the high development and application of the Internet industry, in the future, every item may have its own identification mark and needs to be transmitted to a backend of the technical network system for logical processing. Data of different levels is processed separately. Different kinds of industry data require strong system backing support, which is realized through cloud computing.

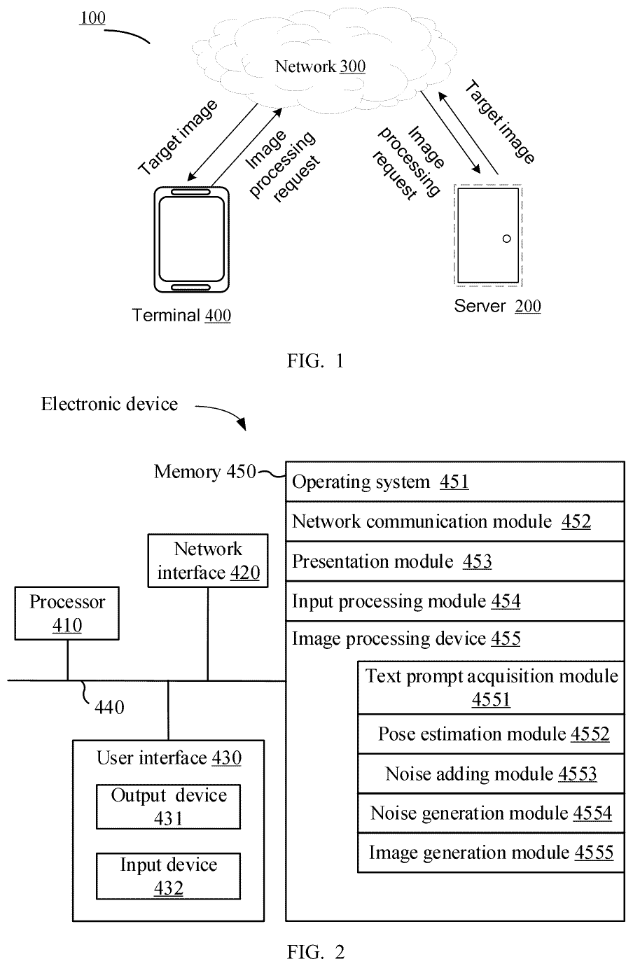

As shown in FIG. 2, FIG. 2 is a block diagram of the electronic device according to one embodiment of the present disclosure. The electronic device includes at least one processor 410, a memory 450, at least one network interface 420, and a user interface 430. The various components in the electronic device are coupled together through a bus system 440. It is understood that the bus system 440 is configured to realize the connection and communication between the various components. In addition to a data bus, the bus system 440 further includes a power bus, a control bus, and a status signal bus. However, for ease of illustration, various buses are included in the bus system 440 shown in FIG. 2.

The at least one processor 410 may be an integrated circuit chip having a signal processing capability, such as a general-purpose processor, a digital signal processor (DSP), or a programmable logic device, a discrete gate, or a transistor logic device, a discrete hardware component, etc. The general-purpose processor is a microprocessor or any conventional processor, etc.

The user interface 430 includes at least one output device 431 configured to display media content. The at least one output device 431 includes one or more speakers and one or more visual display screens. The user interface 430 further includes at least one input device 432. The at least one input device 432 includes user interface components that facilitate user input, such as a keyboard, a mouse, a microphone, a touch screen display, a camera, other input buttons, and control pieces.

The memory 450 may be removable, non-removable, or a combination thereof. For instance, the memory 450 may be a hardware device, such as a solid-state memory, a hard disk drive, an optical drive, etc. Optionally, the memory 450 includes one or more storage devices physically located away from the at least one processor 410.

The memory 450 may include a volatile memory or a non-volatile memory, and may further include both the volatile memory and the non-volatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 is capable of storing data to support various operations, examples of which include programs, modules, and data structures or subsets or supersets thereof, as exemplified below.

An operating system 451 thereof includes system programs configured to process various basic system services and perform hardware-related tasks, such as a framework layer, a core library layer, a driver layer, etc. The operating system 451 is further configured to realize various basic services and processing hardware-based tasks.

A network communication module 452 thereof is configured to communicate with other electronic devices via the at least one (wired or wireless) network interfaces 420. For instance, the at least one network interface 420 includes a BLUETOOTH module, a wireless compatibility certification (WIFI), and a universal serial bus (USB).

A presentation module 453 thereof is configured to present information via the at least one output device 431 (e. g., a display screen, the speakers, etc.) associated with the at least one user interface 430 (e. g., a user interface configured to control an external device and display content and information).

An input processing module 454 is configured to detect one or more user inputs or interactions from the at least one input device 432 and translate detected one or more user inputs or interactions.

In some embodiments, the image processing device in the embodiments of the present disclosure may be implemented in a software manner, and FIG. 2 shows the image processing device 455 stored in the memory 450. The image processing device 455 may be a software in a form such as a program and a plugin. The image processing device 455 includes a text prompt acquisition module 4551, a pose estimation module 4552, a noise adding module 4553, a noise generation module 4554, and an image generation module 4553. These modules are logical and are able to be combined or further split according to functions to be implemented. Functions of these modules are described below.

In some other embodiments, the image processing device in the embodiments of the present disclosure may be implemented in a manner of hardware. For instance, the image processing device in the embodiments of the present disclosure is a hardware decoding processor, and the hardware decoding processor is programmed to perform the image processing method of the present disclosure. For instance, the hardware decoding processor includes one or more application specific integrated circuits (ASICs), a digital signal processor (DSP), a programmable logic device (PLD), a complex programmable logic device (CPLD), a field-programmable gate array (FPGA), or other electronic components.

It should be noted that, according to the understanding of the present disclosure, those skilled in the art are able to apply the image processing method in the embodiments of the present disclosure to a scenario of any image stylization processing, such as an art creation scenario, an unmanned aerial vehicle photography scenario, a game development scenario, a movie, a television production scenario, etc.

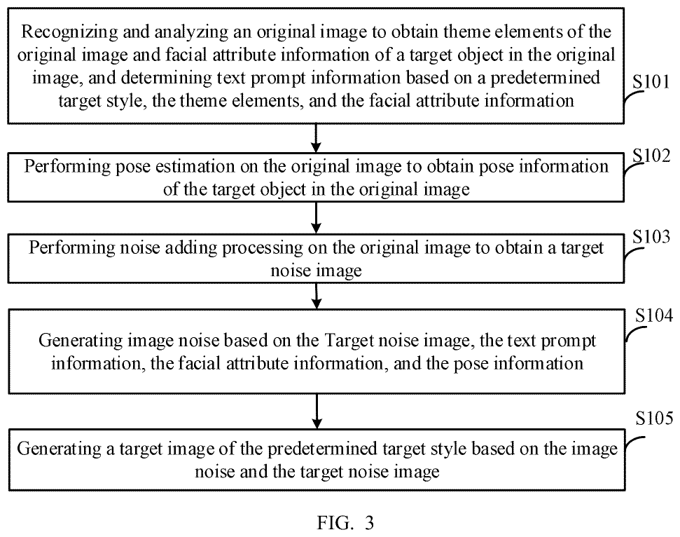

FIG. 3 is a flow chart of the image processing method according to one embodiment of the present disclosure. The image processing method is described in detail by referring to steps shown in FIG. 3. As shown in FIG. 3, taking an execution subject of the image processing method as the server as an example for description, the image processing method includes steps S101-S105.

The step S101 includes recognizing and analyzing an original image to obtain theme elements of the original image and facial attribute information of a target object in the original image, and determining text prompt information based on a predetermined target style, the theme elements, and the facial attribute information.

The original image is any picture including the target object, and the target object is a person or an animal. The original image is input by the user through the client on the terminal. The predetermined target style is any visual style, such as an impressionist style, an abstract art style, an anime style, a specific artist style, or a specific filter effect, etc. The predetermined target style is determined by the image processing system by default, or the predetermined target style is input by the user when the user inputs the original image. For instance, the user inputs a person's picture as the original image through the client of the image processing system, and specifies that the predetermined target style is the anime style. The theme elements of the original image include, but are not limited to, the target object, a background, a possible activity or event in the original image, colors of the original image, etc. For example, when the original image A is a photo of a girl, the hair of the girl is black, the girl wears yellow clothes, and there are flowers in the background, then the target object in the original image is the girl, and the theme elements include “one girl”, “flower”, “black hair”, “yellow clothes”, etc. The facial attribute information is information configured to describe a gender, an age, a smile, an expression, an emotion, an ornament, etc, of the target object.

The text prompt information is prompts configured to guide a pre-trained stable diffusion model to convert the original image into the target image of the predetermined target style. The text prompt information accurately describes the content and structure of the target image after the original image is converted according to the predetermined target style. Different target styles respectively correspond to different style texts. For example, a style text corresponding to the anime style is “anime style”. The recognizing and analyzing the original image refers to performing feature extraction on the original image by the deep learning model (e.g., a convolutional neural network (CNN)) to obtain the theme elements representing the content and structure of the original image and the facial attribute information of the target object. The style text, the theme elements, and the facial attribute information of the target object corresponding to the predetermined target style are jointly served as the text prompt information.

The predetermined target style, the theme elements, and the facial attribute information are integrated into the text prompt information. For instance, the predetermined target style is the anime style, and the theme elements of the original image A include “one girl”, “flower”, “black hair”, “yellow clothes”, etc. The facial attribute information of the original image A is “Girl, Smiling, Without glasses, Corners of the mouth raised, Beautiful”. Then, the generated text prompt information is “anime style, a girl, flower, black hair, yellow clothes, smile, without glasses, corners of the mouth raised, beautiful”.

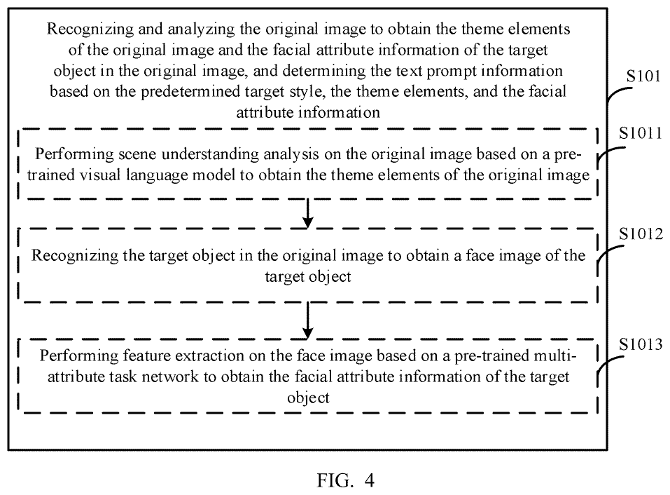

FIG. 4 is another flow chart of an image processing method according to one embodiment of the present disclosure. As shown in FIG. 4, the step S101 of recognizing and analyzing the original image to obtain the theme elements of the original image and the facial attribute information of the target object in the original image, and determining the text prompt information based on the predetermined target style, the theme elements, and the facial attribute information is realized by steps S1011-S1013.

The step S1011 comprises performing scene understanding analysis on the original image based on a pre-trained visual language model to obtain the theme elements of the original image.

The pre-trained visual language model is the deep learning model, and a specific structure of the visual language model is not limited thereto. For instance, the pre-trained visual language model may be a Bootstrapping Language-Image Pre-training (BLIP) model. The scene understanding analysis refers to performing feature recognition and extraction on the original image by the pre-trained visual language model to obtain the theme elements of the original image.

In the embodiment of the present disclosure, the step S1011 of performing scene understanding analysis on the original image based on the pre-trained visual language model to obtain the theme elements of the original image is realized by following steps. First, encoding the original image based on an image encoder in the pre-trained visual language model to obtain an image representation vector; obtaining image description prompt information, and encoding the image description prompt information based on a text encoder in the pre-trained visual language model to obtain a prompt information feature vector; matching the image representation vector and the prompt information feature vector to obtain a target feature vector; and finally, decoding the target feature vector based on the text decoder in the pre-trained visual language model to obtain the theme elements of the original image.

The image description prompt information is a question input by the user for guiding the pre-trained visual language model to understand and recognize the original image. The theme elements of the original image output by the pre-trained visual language model are an answer to the image description prompt information. For instance, the image description prompt information is “what does the image contain?”. The encoder in the pre-trained visual language model (such as the BLIP model) uses image-text contrast loss (ITC) to align visual and language representations. After inputting the image description prompt information and the original image A into the BLIP model, the BLIP model outputs the theme elements as “one girl”, “flower”, “black hair”, “yellow clothes”, etc.

The pre-trained visual language model includes the image encoder, the text encoder, and the text decoder. A process of encoding the original image by the image encoder is as follows: after performing feature extraction on the original image to obtain an initial image vector, performing self-attention processing and feedforward network processing on the initial image vector to obtain the image representation vector. A specific process of self-attention processing and feedforward network processing is not limited in the embodiment of the present disclosure, and a dimension of the image representation vector is not limited. A process of encoding the image description prompt information by the text encoder is as follows: after performing feature extraction on the image description prompt information to obtain an initial text vector, performing self-attention processing on the initial text vector to obtain the prompt information feature vector. A dimension of the prompt information feature vector is not limited in the embodiments of the present disclosure.

A process of matching the image representation vector and the prompt information feature vector to obtain the target feature vector is as follows: calculating a cosine similarity between the image representation vector and the prompt information feature vector, and determining a matching result of the image representation vector and the prompt information feature vector according to the cosine similarity. Specifically, when the cosine similarity is not less than a predetermined similarity threshold, a matched result indicating that the original image is matched with the image description prompt information is obtained. In this case, after performing cross self-attention processing on the image representation vector and the prompt information feature vector and processing the feedforward network, the target feature vector is obtained. In the embodiment of the present disclosure, a specific process of cross-attention processing is not limited. Alternatively, when the cosine similarity is less than the predetermined similarity threshold, a mismatched result indicating that the original image does not match the image description prompt information is obtained. In this case, the pre-trained visual language model fails to output the answer to the image description prompt information, that is, the theme elements of the original image are not output.

After obtaining the target feature vector, the process of decoding the target feature vector by the text decoder is as follows. First, the text decoder initializes an initial text state of a theme element generation process (token, for example, beginning of sequence [BOS], representing start), and the text decoder predicts a first text by using a self-attention mechanism and a cross-attention mechanism according to the initial text state and the target feature vector. The first text may be a single word. Once the first text is generated, the text decoder uses the first text as a new context and again predicts a next text by using the self-attention mechanism and the cross-attention mechanism. The theme element generation process is repeated until the text decoder generates a special end-of-text state (e.g, end of sequence (EOS), representing ending), or the number of generated texts reaches a predetermined maximum number of texts. Finally, texts output by the text decoder are configured as the theme elements of the original image.

The embodiment of the present disclosure controls the pre-trained visual language model through the image description prompt information, which improves the accuracy of the theme elements, thereby improving the accuracy of the text prompt information in describing the content and structure in the original image, and improving the relevance between the stylized target image (i.e., the target image) and the original image.

The step S1012 includes recognizing the target object in the original image to obtain a face image of the target object.

Specifically, the target object in the original image is recognized and located first to obtain a face image of the target object. For instance, when the target object is a person, a face recognized and located by the face recognition technology is determined as the face image. Alternatively, a face detection algorithm (such as a Haar cascade classifier, etc.) is applied to detect the face in the original image, and a location and a size of the face are determined through a bounding box. Once the face is detected in the original image, a separate face image is cropped according to the bounding box that is detected.

The step S1013 includes performing feature extraction on the face image based on a pre-trained multi-attribute task network to obtain the facial attribute information of the target object.

Specifically, the feature extraction is performed on the face image based on the pre-trained multi-attribute task network to obtain the facial attribute information of the target object. A network structure of the pre-trained multi-attribute task network is not limited in the embodiment of the present disclosure, and may be a deep learning network.

In the embodiment of the present disclosure, the step S1013 of performing feature extraction on the face image based on the pre-trained multi-attribute task network to obtain the facial attribute information of the target object is realized by performing feature extraction on the face image based on the pre-trained multi-attribute task network to obtain at least one of object attribute information, wear information, an expression score, an aesthetic score, and facial key points of the target object; and generating the facial attribute information based on at least one of the object attribute information, the wear information, the expression score, the aesthetic score, and the facial key points of the target object.

Specifically, the feature extraction is performed on the face image based on the pre-trained multi-attribute task network to obtain at least one of the object attribute information, the wear information, the expression score, the aesthetic score, and the facial key points of the target object. The object attribute information is obtained by combining gender information and age information of the target object. For instance, when performing feature extraction on the face image to obtain information that the gender information of the target object being “female”, the age information of “12”, and the age information of the target object being less than a first age threshold of “18”, the gender information “female” and the age information of “12” are combined to output “girl” as the object attribute information. Alternatively, when the feature extraction is performed on the face image to obtain information that the gender information of the target object being “female”, the age information being “25”, and the age information of the target object is greater than the first age threshold of “18” and less than a second age threshold of “30”, the gender information “female” and the age information of “25” are combined to output “woman” as the object attribute information. The wear information includes, but is not limited to, glasses state information, mask state information, ornament state information, etc. of the target object. For instance, the glasses state information may include a plurality of state information such as without glasses, wearing ordinary glasses, wearing sunglasses, etc. The expression score is a score configured to reflect an emotional state of the target object by performing feature extraction on a facial expression of the target object by the pre-trained multi-attribute task network. The expression score includes, but is not limited to, a smile score, a sad score, an angry score, a fear score, etc. of the target object. The aesthetic score is a score reflecting a facial attractiveness of the target object. The facial key points include, but are not limited to recognizing and locating the face of the target object by the pre-trained multi-attribute task network to obtain key points located on contours of facial organs. For instance, the facial key points may include key points located on contours such as eyes, nose, and mouth. In some embodiments, location information of the facial key points is further obtained through facial recognition.

It should be noted that in addition to the object attribute information, the wear information, the expression score, the aesthetic score and the facial key points in the embodiment of the present disclosure, other information is also allowed to be obtained by feature extraction of the face image according to specific needs. The facial attribute information is determined based on at least one of the object attribute information, the wear information, the expression score, the aesthetic score, and the facial key points of the target object. The embodiment of the present disclosure obtains the facial attribute information by comprehensively considering different attributes of the target object, providing rich contextual information for image style conversion, and the text prompt information generated thereto is detailed and vivid, improving the relevance between the stylized target image and the original image, and realizing fine-grained generation of the target image.

In some embodiments, the step of generating the facial attribute information based on at least one of the object attribute information, the wear information, the expression score, the aesthetic score, and the facial key points of the target object is realized as follows. First, eye state information and lip state information are determined based on the facial key points; then, when the expression score is greater than a predetermined first threshold, an expression prompt is obtained, and the facial attribute information is generated based on at least one of the object attribute information, the wear information, the expression prompt, the eye state information, and the lip state information. Alternatively, when the aesthetic score is greater than a predetermined second threshold, an aesthetic prompt is obtained, and the facial attribute information is generated based on at least one of the object attribute information, the wear information, the aesthetic prompt, the eye state information, and the lip state information.

Specifically, the eye state information and the lip state information of the target object are determined based on the facial key points. The eye state information includes, but is not limited to whether the eyes are open, whether the eyes are in a smiling state, etc. The lip state information includes, but is not limited to whether the lips are closed, whether corners of the mouth are raised, etc. For instance, the facial key points include location information of key points on the eyes and the lips. The image processing system stores default values for each of the key points on the eyes and lips for the same type of objects. The location information of the key points on the eyes and the lips is compared with corresponding default values to determine the eye state information and the lip state information of the target object. Exemplarily, when the target object is a person, and the location information of the key points at the corners of the mouth in the facial key points is greater than default values of key points at the corners of the mouth in a person type, then the lip state information of the corners of the mouth raised is obtained.

The embodiment of the present disclosure does not limit specific values of the predetermined first threshold and the predetermined second threshold, which are determined according to actual needs. The predetermined first threshold is a numerical value configured to classify expressions according to expression scores. The expression prompt is configured to represent an expression type of the target object. Taking the expression score as the smile score as an example, the expression type of the target object is smile and no smile. The predetermined first threshold is 80. When the expression score is 90, which is greater than the predetermined first threshold of 80, the expression prompt “smile” is obtained. When the expression score is 50, which is less than the predetermined first threshold of 80, the expression is in a default no-smile state, and there is no need to obtain the expression prompt. After obtaining the expression prompt, information integration is performed to generate the facial attribute information based on at least one of the object attribute information, the wear information, the expression prompt, the eye state information, and the lip state information. For instance, the facial attribute information obtained may be “smile, girl, without glasses, corners of the mouth raised”.

Similarly, the predetermined second threshold is a numerical value configured to classify the facial attractiveness of the target object according to the aesthetic score. For instance, when the aesthetic score is greater than the predetermined second threshold, the aesthetic prompt “beautiful” is obtained. Alternatively, when the aesthetic score is not greater than the predetermined second threshold, there is no need to obtain the aesthetic prompt. Alternatively, when the aesthetic score is less than a predetermined third threshold, an aesthetic prompt “ugly” is obtained. After obtaining the aesthetic prompt, information integration is performed to generate the facial attribute information based on at least one of the object attribute information, the wear information, the aesthetic prompt, the eye status information, and the lip status information. For instance, the facial attribute information is “girl, without glasses, corners of the mouth raised, beautiful”.

In some embodiments, both the expression prompt and the aesthetic prompt are obtained, and the facial attribute information is generated based on at least one of the object attribute information, the wear information, the expression prompt, the aesthetic prompt, the eye state information, and the lip state information. For instance, the facial attribute information is “girl, smiling, without glasses, corners of the mouth raised, beautiful”.

The embodiment of the present disclosure combines facial expression analysis and image aesthetics evaluation, and the facial attribute information generated by the present disclosure is rich, which well reflects the content and structure in the original image, making the generated text prompt information detailed and vivid, improving the relevance between the stylized target image and the original image, and no additional text prompts need to be added manually, thereby improving the generation efficiency of the target image.

The text prompt information generated by the embodiment of the present disclosure not only reflects the content and structure of the original image, but also takes into account the requirements of the predetermined target style, provides clear guidance for image style conversion, improves the relevance between the stylized target image and the original image.

The step S102 comprises performing pose estimation on the original image to obtain pose information of the target object in the original image;

The pose estimation refers to using a pre-trained pose estimation model to predict a pose of the target object in the original image and obtain pose information of the target object. The pose information of the target object includes key point information of the target object. Taking the target object as the person as an example, the key point information of the target object is key joint locations, such as two-dimensional coordinates of a shoulder, an elbow, a wrist, a hip, a knee, and an ankle. The embodiment of the present disclosure does not specifically limit the pre-trained pose estimation model. For instance, the pre-trained pose estimation model is an OpenPose model, an AlphaPose model, or an HRNet model. The embodiment of the present disclosure uses a human body pose estimation technology DWPOSE to estimate the pose of the target object in the original image and obtain the pose information of the target object.

The step S103 comprises performing noise adding processing on the original image to obtain a target noise image.

A noise-adding processing is performed, by a pre-trained stable diffusion model, on the original image once based on Gaussian noise to obtain the target noise image. Alternatively, multiple times of noise adding processing are performed, by the pre-trained stable diffusion model, on the original image based on the Gaussian noise to obtain a noise image. For instance, the noise-adding processing is performed on the original image, by the pre-trained stable diffusion model, based on the Gaussian noise to obtain a target noise image. The noise-adding processing is performed on a t^{th} noise image based on the Gaussian noise to obtain a (t+1)^{th}noise image, where t=1, 2, . . . , T−1. T is an integer greater than 1. In the embodiment of the present disclosure, the target noise image is the T^{th} noise image, that is, the target noise image is a last output diffusion result of a diffusion process of the pre-trained stable diffusion model.

The step S104 comprises generating image noise based on the target noise image, the text prompt information, the facial attribute information of the target object in the original image, and the pose information of the target object in the original image.

The pre-trained stable diffusion model is configured to perform an inverse diffusion process on the target noise image. The text prompt information, the face image, and the pose information in the original image are input into the pre-trained stable diffusion model. A decoupling cross-attention processing is performed on the text prompt information and the face image by the pre-trained stable diffusion model, and then the text prompt information and the face image are fused to obtain the image noise corresponding to the target noise image.

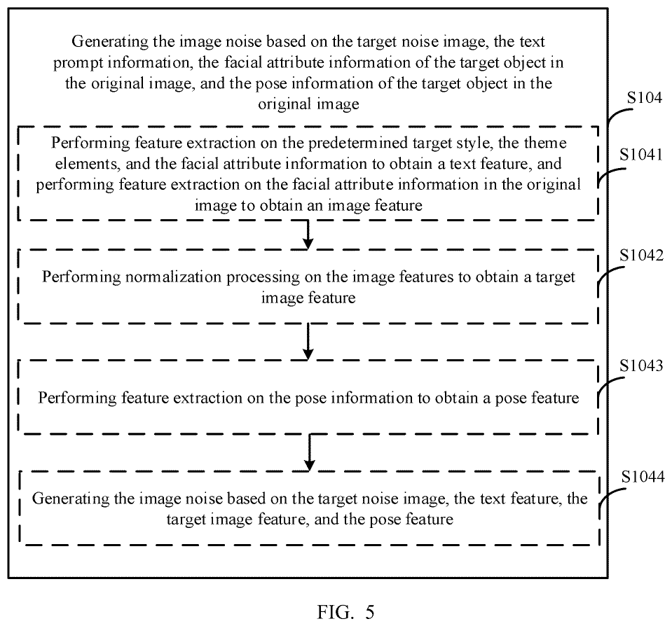

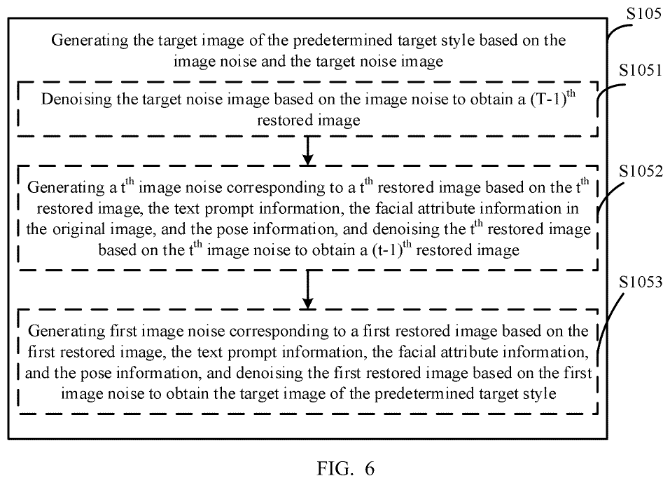

As shown in FIG. 5, FIG. 5 is a flow chart of the step S104. The step S104 of generating the image noise based on the target noise image, the text prompt information, the facial attribute information of the target object in the original image, and the pose information of the target object in the original image is realized by steps S1041-S1044.

The step S1041 comprises performing feature extraction on the predetermined target style, the theme elements, and the facial attribute information to obtain text feature, and performing feature extraction on the facial attribute information in the original image to obtain an image feature.

A word embedding technology (such as Word2vec) is adopted to convert the predetermined target style, the theme elements, and the facial attribute information into a continuous vector representation to obtain the text feature. The feature extraction is performed on the face image by a pre-trained CNN (such as a VGG16 network or a ResNet network) to obtain the image feature. For instance, the feature extraction is performed on the face image by a ResNet100 network pre-trained based on a Cosface loss function (a loss function based on the cosine similarity) to obtain the image feature. Vector dimensions of the image feature may be the same as or different from vector dimensions of the text feature.

The step S1042 includes performing normalization processing on the image feature to obtain a target image feature.

The image feature is normalized by linear layers and layer normalization to obtain the target image feature. Vector dimensions of the target image feature are the same as the vector dimensions of the text feature.

The step S1043 comprises performing feature extraction on the pose information to obtain a pose feature.

The pose information (such as the joint locations, a motion angle, etc.) is converted into a numerical vector to obtain the pose feature. For instance, the pose information is compressed into a low-dimensional feature vector using a dimensionality reduction technology such as principal component analysis (PCA) to obtain the pose feature.

The step S1044 comprises generating the image noise based on the target noise image, the text feature, the target image feature, and the pose feature.

Decoupling cross-attention is performed on the target noise image and the text feature to obtain a first attention feature, and decoupling cross-attention is performed on the target noise image and the target image feature to obtain a second attention feature. The first attention feature and the second attention feature and the pose feature are fused to obtain the image noise of the target noise image. The decoupling cross-attention processing allows information interaction between different modalities while maintaining respective modal features. The decoupling cross-attention processing includes: first, configuring the target noise image as a query and configuring the text feature as a key (index keys) and a value (content values), and calculating attention weights of the target noise image to the text feature to obtain the first attention feature. Similarly, the target noise image is configured as a query, the target image feature is configured as a key and a value, and attention weights of the target noise image to the target image feature are calculated to obtain the second attention feature.

In the embodiment of the present disclosure, the image noise is generated by combining the text feature, the target image feature, and the pose feature, so that the target image obtained based on the image noise conforms to the content and structure of the original image, the relevance between the stylized target image and the original image is improved, and the detail richness of the target image is improved.

In the embodiment of the present disclosure, the step S1044 of generating the image noise based on the target noise image, the text feature, the target image feature, and the pose feature is realized by performing self-attention processing based on the target noise image and the text feature to obtain the first attention feature; performing self-attention processing based on the target noise image and the target image feature to obtain a second attention feature; and fusing the first attention feature, the second attention feature, and the pose feature to obtain the image noise corresponding to the target noise image.

First, self-attention processing is performed on the target noise image and the text feature, and self-attention processing is performed on the target noise image and the target image feature, and then obtained attention feature are fused with the pose feature to generate the image noise corresponding to the target noise image. The feature extraction is performed on the target noise image by the pre-trained stable diffusion model to obtain a generated feature. The generated feature is configured as an input, and attention weights between the generated feature and the text feature are calculated to obtain the first attention feature. Similarly, self-attention processing is performed on the generated feature and the target image feature to obtain the second attention feature. The first attention feature satisfies the following formula:

$$Z = Attention ( Q , K , V ) = Softmax ( \frac{{QK}^{T}}{\sqrt{d}} ) V \qquad ( 1 )$$

Z represents the first attention feature. Attention represents the self-attention processing. Softmax is a normalization function. d is the vector dimensions of the text feature, Q is the query matrix, Q=W_{q}×xᵢ. xᵢ is the generated feature obtained by extracting the features of the target noise image by an i^{th} network layer of the denoising network in the pre-trained stable diffusion model, W_{q} represents pre-trained weight parameters in the pre-trained stable diffusion model. K=Wₖ×text feature. V=Wᵥ×text feature. Wₖ and Wᵥ are pre-trained weight parameters.

the second attention feature satisfies the following formula (2):

$${Z}^{′} = Attention ( Q , {K}^{′} , {V}^{′} ) = Softmax ( \frac{{QK}^{{′}^{T}}}{\sqrt{d}} ) {V}^{′} . \qquad ( 2 )$$

Z′ represents the second attention feature. Q is equal to the query matrix Q in a calculation process of the first attention feature.

$$K = {W}_{k}^{′} \times a target image feature . V = {W}_{v}^{′} \times \times a target image feature . {W}_{k}^{′} and {W}_{v}^{′}$$

are pre-trained weight parameters.

After obtaining the first attention feature and the second attention feature, the text weights corresponding to the first attention feature and the image weights corresponding to the second attention feature are obtained. The first attention feature is weighted with the text weights to obtain a weighted first attention feature. The second attention feature is weighted with the image weights to obtain weighted a second attention feature. The weighted first attention feature and the weighted second attention feature are added together, and a sum thereof is weightedly fused (weighted averaging or direct weighted summing) or directly spliced with the pose feature to obtain the image noise corresponding to the target noise image.

In some embodiments, a stylized weight parameter is further obtained. The stylized weight parameter is flexibly adjusted according to needs of a specific business scenario. For instance, when the target image is more stylized, the stylized weight parameter is lowered, or when the target image is more realistic in terms of character features, the stylized weight parameter is increased. After the second attention feature is weighted based on the stylized weight parameter, the weighted second attention feature is summed with the first attention feature, and a sum thereof is fused with the pose feature to obtain the image noise corresponding to the target noise image.

In the embodiment of the present disclosure, the image noise that is more in line with the context is generated by performing decoupling cross-attention calculation between the target noise image and the text feature, the target noise image and the target image feature, and combining the pose information, thereby improving the relevance between the stylized target image and the original image, and realizing a more fine-grained generation of the target image.

In some embodiments, the step of fusing the first attention feature, the second attention feature and the pose feature to obtain the image noise corresponding to the target noise image is realized by the following steps. First, the first attention feature, the second attention feature, and the pose feature are fused to obtain target noise; then, the weight parameters corresponding to the predetermined target style are obtained; finally, the image noise corresponding to the target noise image is determined based on the target noise and the weight parameters.

The weight parameters corresponding to the predetermined target style are learned based on a pre-trained LoRa fine-tuning branch network. A fine-tuning branch network corresponding to the predetermined target style is added to a pre-trained stable diffusion network by a LoRa fine-tuning method. The weight parameters of the LoRa fine-tuning branch network are obtained, which are the weight parameters corresponding to the predetermined target style. The specific process of fusing the first attention feature, the second attention feature, and the pose feature to obtain the target noise refers to a specific process of fusing the first attention feature, the second attention feature, and the pose feature in the above embodiment, to obtain the image noise corresponding to the target noise image, which is not repeatedly described herein. The target noise is weighted based on the weight parameters corresponding to the predetermined target style to obtain the image noise corresponding to the target noise image.

In the embodiment of the present disclosure, the LoRa fine-tuning method is adopted to integrate the predetermined target style into the image processing process, so that the image noise generated by the LoRa fine-tuning method is in line with an expected visual effect.

The step S105 comprises generating a target image of the predetermined target style based on the image noise and the target noise image.

The target noise image is subjected to the inverse diffusion process based on the pre-trained stable diffusion model, and the target noise image is gradually denoised based on the image noise to obtain the target image of the predetermined target style.

As shown in FIG. 6, FIG. 6 is a flow chart of the step S105 of generating the target image of the predetermined target style based on the image noise and the target noise image. The step S105 is realized by Steps S1051-S1055.

The step S1051 includes denoising the target noise image based on the image noise to obtain a (T−1)^{th}restored image.

T is an integer greater than 1.

For instance, the denoising network in the pre-trained stable diffusion model is configured to perform preliminary denoising on the target noise image based on the image noise to obtain the (T−1)^{th}restored image. The (T−1)^{th}restored image reduces the image noise of the T^{th} noise image, but still retains some noise features.

The step S105 includes generating a t^{th} image noise corresponding to a t^{th} restored image based on the t^{th} restored image, the text prompt information, the facial attribute information in the original image, and the pose information, and denoising the t^{th} restored image based on the t^{th} image noise to obtain a (t−1)^{th} restored image.

$$t = T - 1 , T - 2 , … , 2.$$

For instance, for t=T−1, T−2, . . . , 2, following operations are performed. Based on the t^{th} restored image, further denosing processing is performed by the denoising network in the pre-trained stable diffusion model to reduce noise in the t^{th} restored image. A specific process of generating the t^{th} image noise corresponding to the t^{th} restored image based on the t^{th} restored image, the text prompt information, the face image, and the pose information is consistent with the process of generating the image noise based on the target noise image, the text prompt information, the face image, and the pose information in the step S105, and is not described in details herein The t^{th} image noise is applied to the t^{th} restored image to obtain the (t−1)^{th} restored image, and then a next iteration is entered.

The step S1053 includes generating a first image noise corresponding to the first restored image based on the first restored image, the text prompt information, the facial attribute information, and the pose information, and denoising the first restored image based on the first image noise to obtain the target image of the predetermined target style.

For instance, when t is 2, a new first restored image is obtained. At this time, the step of generating the first image noise corresponding to the first restored image based on the first restored image, the text prompt information, the face image, and the pose information is consistent with the step of generating the image noise based on the target noise image, the text prompt information, the face image, and the pose information in the step S104, which is not described in detail herein. The first restored image is denoised, by the denoising network in the pre-trained stable diffusion model, based on the first image noise to obtain the target image of the predetermined target style.

In the process of image stylization of the embodiments of the present disclosure, the noise adding processing is performed on the original image to obtain the target noise image; the image noise is generated based on the noise images, the text prompt information, the face image, and the pose information. The target image of the predetermined target style is generated based on the image noise and the target noise image. The text prompt information is determined based on the predetermined target style, the theme elements, and the face image. The face image is obtained by performing facial recognition on the original image, and the pose information is obtained by performing pose estimation on the target object in the original image. Compared to the method of generating the images by the pre-trained diffusion model or the pre-trained stable diffusion model in the related art, the embodiments of the present disclosure integrate the text prompt information, the face image, and the pose information related to the original image, so that the target image is similar to the original image, and the original image is accurately converted into the target image of the predetermined target style, thereby improving the relevance of the target image to the original image. In addition, compared to the related art of manually inputting a large amount of text prompts, in the embodiments of the present disclosure, the text prompt information is determined by original image and the predetermined target style. Namely, the present disclosure omits the need for manually inputting the text prompts, thereby improving the accuracy and efficiency of image stylization processing.

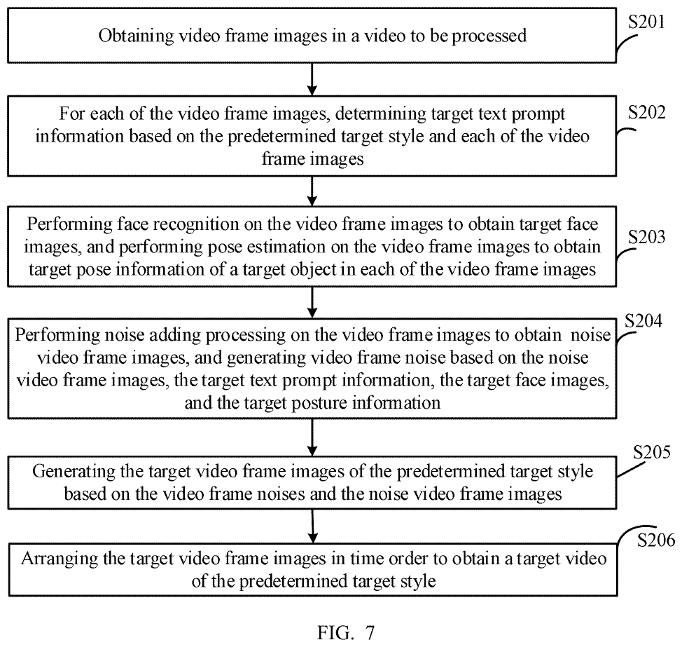

As shown in FIG. 7, FIG. 7 is another flow chart of the image processing method according to one embodiment of the present disclosure. In some embodiments, the image processing method of the present disclosure further includes steps S201-S206.

The step S201 includes obtaining video frame images in a video to be processed.

The video to be processed may be any form of video, which includes, but is not limited to a video of a person, a video of an animal, etc. The video to be processed is input by the user through the client on the terminal. The video to be processed is composed of the video frame images, and the video frame images are continuously extracted from the video to be processed based on a frame rate of the video to be processed.

The step S202 includes for each of the video frame images, determining target text prompt information based on the predetermined target style and each of the video frame images.

The target text prompt information is a command (Prompt) for guiding the pre-trained stable diffusion model to convert the video frame images into target video frame images of the predetermined target style. The target text prompt information accurately describes the content and structure of the target video frame images after the video frame images are converted into the target video frame images of the predetermined target style. For each of the video frame images, a specific step of determining the target text prompt information based on the predetermined target style and the video frame images is similar to the step of determining the text prompt information based on the predetermined target style and the original image in the step S101 in the above embodiment, which is not described in detail herein.

The step S203 includes performing face recognition on the video frame images to obtain target face images, and performing pose estimation on the video frame images to obtain target pose information of a target object in each of the video frame images.

The step of performing face recognition on the video frame images to obtain target face images is similar to the step S1012 of recognizing the target object in the original image to obtain the face image of the target object in the above embodiment, which is not described in detail herein. The step of performing pose estimation on the video frame images to obtain the target pose information of the target object in each of the video frame images may refer to the step S102 of performing pose estimation on the original image to obtain the pose information of the target object in the original image, which is not described in detail herein.

The step S204 includes performing noise adding processing on the video frame images to obtain noise video frame images, and generating video frame noise based on the noise video frame images, the target text prompt information, the target face images, and the target pose information.

The step of performing the noise adding processing on the video frame images to obtain the noise video frame images may refer to the step S103 of performing the noise adding processing on the original image to obtain the target noise image in the above embodiment, which is not described in detail herein. The step of generating video frame noise based on the noise video frame images, the target text prompt information, the target face images, and the target pose information may refer to the step S104 of generating the image noise based on the target noise image, the text prompt information, the facial attribute information of the target object in the original image, and the pose information of the target object in the original image in the above embodiment, which is not described in detail herein.

The step S205 includes generating the target video frame images of the predetermined target style based on the video frame noise and the noise video frame images.

The step of generating the target video frame images of the predetermined target style based on the video frame noise and the noise video frame images may refer to the step S105 of generating the target image of the predetermined target style based on the image noise and the target noise image in the above embodiment, which is not described in detail herein.

The step S206 includes arranging the target video frame images in time order to obtain a target video of the predetermined target style.

In the video to be processed, each of the video frame images corresponds to specific time information, so each of the target video frame images after denoising also corresponds to a specific time information. After obtaining the target video frame images, the target video frame images are arranged according to corresponding time information to obtain the target video of the predetermined target style.

In the embodiment of the present disclosure, each of the video frame images is processed in the video to be processed, so that each of the video frame images conforms to the predetermined target style, while retaining the features described by the text prompt information, the face image and the pose information thereof, thereby generating the target video of the predetermined target style, and improving the relevance between the stylized target video (ie.e, the target video) and the video to be processed.

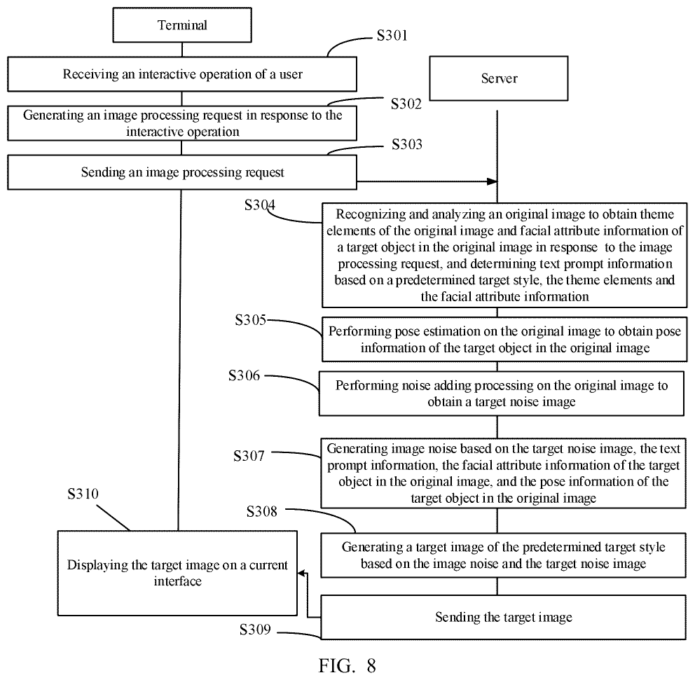

As shown in FIG. 8, FIG. 8 is another flow chart of the image processing method according to one embodiment of the present disclosure. The image processing method includes steps S301-S310.

The step S301 includes receiving an interactive operation from a user by a terminal.
The interactive operation may be an operation of inputting an original image, an operation of inputting a predetermined target style, an operation of clicking to start generating a target image, etc. The user may perform any interactive operation on the client of an image processing application through the terminal.

The step S302 includes generating an image processing request, by the terminal, in response to the interactive operation.

The step S302 includes sending the image processing request, by the terminal, to a server.

The step S303 includes recognizing and analyzing the original image to obtain theme elements of the original image and facial attribute information of a target object in the original image, by the server, in response to the image processing request, and determining text prompt information based on the predetermined target style, the theme elements, and the facial attribute information.

The step of recognizing and analyzing the original image to obtain the theme elements of the original image and the facial attribute information of the target object in the original image and determining the text prompt information based on the predetermined target style, the theme elements, and the facial attribute information may refer to the step S101 of the above embodiment, which is not described in detail herein.

The step S305 includes performing pose estimation on the original image to obtain pose information of the target object in the original image.

The step of performing the pose estimation on the original image to obtain the pose information of the target object in the original image may refer to the step S102 of the above embodiment, which is not described in detail herein.

The step S306 includes performing noise adding processing on the original image to obtain a target noise image.

The step of performing the noise adding processing on the original image to obtain the target noise image may refer to the step S103 of the above embodiment, which is not described in detail herein.

The step S307 includes generating image noise based on the target noise image, the text prompt information, the facial attribute information of the target object in the original image, and the pose information of the target object in the original image.

The step of generating the image noise based on the target noise image, the text prompt information, the facial attribute information of the target object in the original image, and the pose information of the target object in the original image may refer to the step S104 of the above embodiment, which is not described in detail herein.

The step S308 includes generating a target image of the predetermined target style based on the image noise and the target noise image.

The step of generating the target image of the predetermined target style based on the image noise and the target noise image may refer to the step S105 of the above embodiment, which is not described in detail herein.

The step S309 includes sending the target image to the terminal by the server.

The step S310: includes displaying the target image on a current interface by the terminal.

In the process of image stylization, in the embodiments of the present disclosure, the noise adding processing is performed on the original image to obtain the target noise image; the image noise is generated based on the target noise image, the text prompt information, the face image, and the pose information. The target image of the predetermined target style is generated based on the image noise and the target noise image. The text prompt information is determined based on the predetermined target style, the theme elements, and the face image. The face image is obtained by performing facial recognition on the original image, and the pose information is obtained by performing pose estimation on the target object in the original image. Compared to the method of generating the images by the pre-trained diffusion model or the pre-trained stable diffusion model in the related art, the embodiments of the present disclosure integrate the text prompt information, the face image, and the pose information related to the original image, so that the target image is similar to the original image, and the original image is accurately converted into the target image of the predetermined target style, thereby improving the relevance of the target image to the original image. In addition, compared to the related art of manually inputting a large amount of text prompts, in the embodiments of the present disclosure, the text prompt information is determined by original image and the predetermined target style. Namely, the present disclosure omits the need for manually inputting the text prompts, thereby improving the accuracy and efficiency of image stylization processing.

Furthermore, an exemplary application of the embodiment of the present disclosure in an actual application scenario is described as follows.

The embodiment of the present disclosure provides an image processing method. Taking a scenario of anime stylization of an original image as an example, the image processing method is an anime stylization method that integrates scene understanding, pose control, and identity preservation. In addition, the embodiment of the present disclosure uses a face multi-attribute estimation network to estimate a gender, an age, a glasses wearing condition, a smile condition, etc. of the target object as the text prompts and generates an anime-style target image in a fine-grained manner.

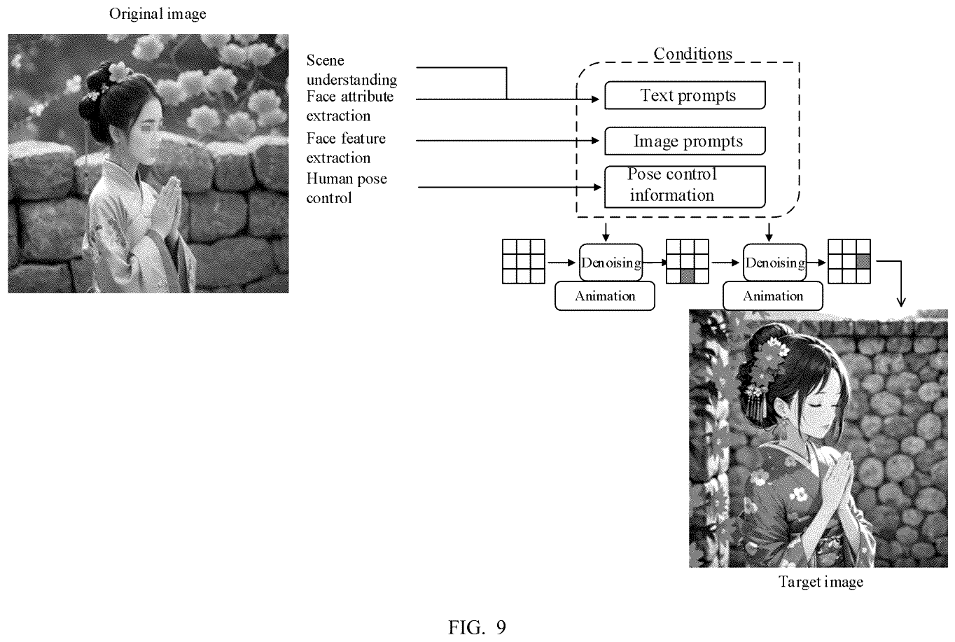

FIG. 9 is a schematic diagram of the image processing method according to one embodiment of the present disclosure. As shown in FIG. 9, in the embodiment of the present disclosure, text prompts (corresponding to the text prompt information in the above embodiment) are obtained by performing scene understanding and facial attribute extraction on the original image. Image prompts (corresponding to the face image in the above embodiment) are obtained by extracting facial features from the original image. Human body pose control is performed on the original image to obtain pose control information (corresponding to the pose information in the above embodiment). The text prompts, the image prompts, and the pose control information are configured as conditions together, and the pre-trained stable diffusion model is configured to denoise the original image after adding noise. At the same time, the LoRa fine-tuning method is configured to perform cartoon fine-tuning during the denoising process, so that the target image is closer to the anime style. The pre-trained diffusion model and the pre-trained stable diffusion model are introduced below.

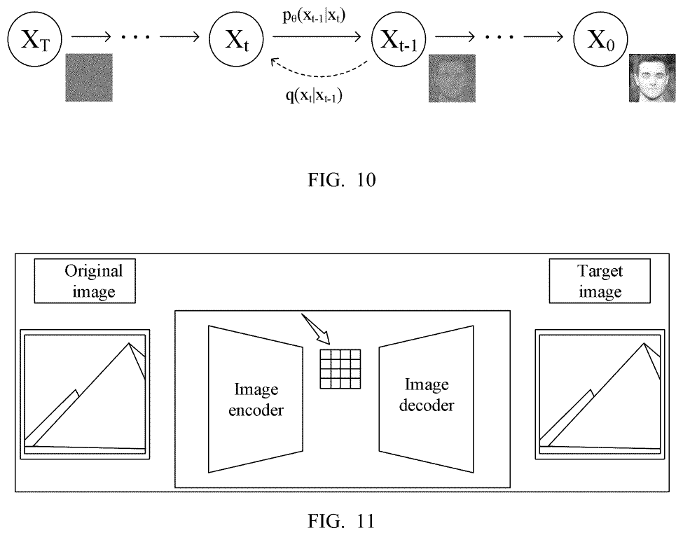

FIG. 10 is a flow chart of an image processing process of the pre-trained diffusion model according to one embodiment of the present disclosure. Processing processes of the pre-trained diffusion model include the diffusion process and the inverse diffusion process. The diffusion process refers to a process of adding noise from x₀ to X_{T}. At this time, x₀ is the original image, and X_{T} is the target noise image finally obtained after adding noise to the original image. The inverse diffusion process refers to a process from X_{T} to x₀. At this time, X_{T} is the target noise image, and x₀ is the target image. An image generation process refers to the inverse diffusion process, which refers to the process of gradually generating the target image x₀ by gradually estimating the image noise εₜ. pθ(xₜ₋₁|xₜ) refers to a probability of obtaining the restored image xₜ₋₁ at a (t−1)^{th} moment under a condition that the restored image xₜ at the t^{th} moment has been obtained in the inverse diffusion process. q(xₜ|xₜ₋₁) refers to a probability of obtaining the noise image at the t^{th} moment under a condition that the noise image xₜ₋₁ at the (t−1)^{th} moment has been obtained in the diffusion process. The loss function of the pre-trained diffusion model satisfies the following formula (3).

$${L}_{simple} = {E}_{t , {x}_{0} , ε} [ {‖ ε - {ϵ}_{θ} ( {x}_{t} , t ) ‖}^{2} ] \qquad ( 3 )$$

L_{LDM} represents the loss function of the pre-trained diffusion model. E_{ε(x),y,ε˜N(0,1),t} represents under known conditions t, ε(x), y, and ε. ε represents a known Gaussian noise. ∈_{θ}(zₜ,t,τ_{θ}(y)) represents the t^{th} image noise estimated by the pre-trained diffusion model. A value of t is between 0 and T. T is an integer greater than 0. t represents the t^{th} moment in the diffusion process. xₜ is the noise image at the t^{th} moment. x₀ is the target image to be estimated by the pre-trained diffusion model (known in the training process).

For the noise image generation at (t−1)^{th} moment, the pre-trained diffusion model estimates the t^{th} image noise. The noise image at (t−1)^{th} moment satisfies the following formula (4).

$${x}_{t - 1} = \frac{1}{\sqrt{{α}_{t}}} ( {x}_{t} - \frac{1 - {α}_{t}}{\sqrt{1 - {α}_{t}}} {ϵ}_{θ} ( {x}_{t} , t ) ) + {b}_{t} Z \qquad ( 4 )$$

Z represents noise obtained by random sampling and is a random value between 0-1. σₜ represents a standard deviation of the noise. σₜ=\sqrt{βₜ}. βₜ represents a variance applied in the diffusion process and is a known value. αₜ=1˜βₜ. The target image x₀ is obtained by repeatedly iterating the formula (4).

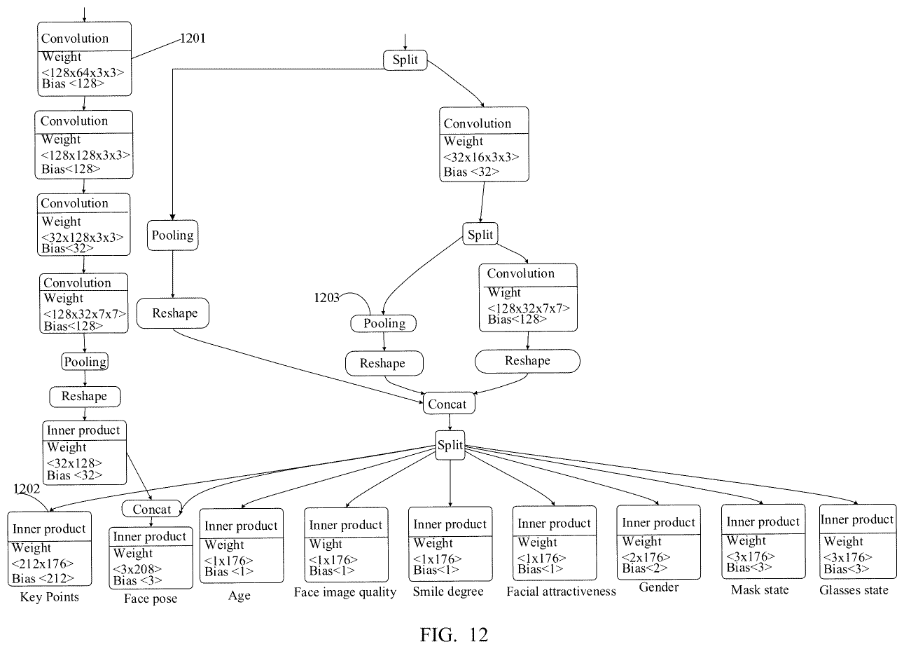

FIG. 11 is a flow chart of an image processing process of the pre-trained stable diffusion model according to one embodiment of the present disclosure. As shown in FIG. 11, the pre-trained stable diffusion model no longer directly estimates the noise of generated noise images, but estimates the noise of the latent space in an intermediate process. The pre-trained stable diffusion model proposes the concept of a guidance condition. The image encoder encodes the guidance condition to obtain the vector representation of the latent space. The image decoder estimates the noise of the latent space step by step through the guidance condition, thereby converting the original image into the target image. The loss function of the pre-trained stable diffusion model satisfies the following formula (5).

$${L}_{LDM} = {E}_{ε ( x ) , y , ε \sim N ( 0 , 1 ) , t} [ {‖ ε - {ϵ}_{θ} ( {z}_{t} , t , {τ}_{θ} ( y ) ) ‖}_{2}^{2} ] \qquad ( 5 )$$

L_{LDM} represents the loss function of the pre-trained stable diffusion model. E_{ε(x),y,ε˜N(0,1),t} represents the known conditions t, ε(x), y, and ε. ε represents the known Gaussian noise. ∈_{θ}(zₜ,t,τ_{θ}(y)) represents the t^{th} image noise estimated by the pre-trained stable diffusion model. The value of t is between 0-T, and T is the integer greater than 0. t represents the t^{th} moment in the diffusion process. zₜ represents the latent space at the t^{th} moment. τ^{θ}(y) represents the guidance condition, such as the text prompts.

A process of obtaining the text prompts is illustrated as follows. The acquisition of the text prompts includes scene attribute prompts (corresponding to the theme elements in the above embodiment) and face attribute prompts (corresponding to the facial attribute information in the above embodiment). The scene attribute prompts are obtained by the Blip model. The encoder of a visual language understanding generation model (corresponding to the pre-trained visual language model in the above embodiment) uses the image-text contrast loss (ITC) to align the visual representations and the language representations. By inputting the original image and the image description prompt information (e.e., prompts: What does the image contain?), the theme elements in the original image, that is, the scene attribute prompts, are obtained. The facial attribute prompts are obtained by extracting facial features from the original image by the pre-trained multi-attribute task network.

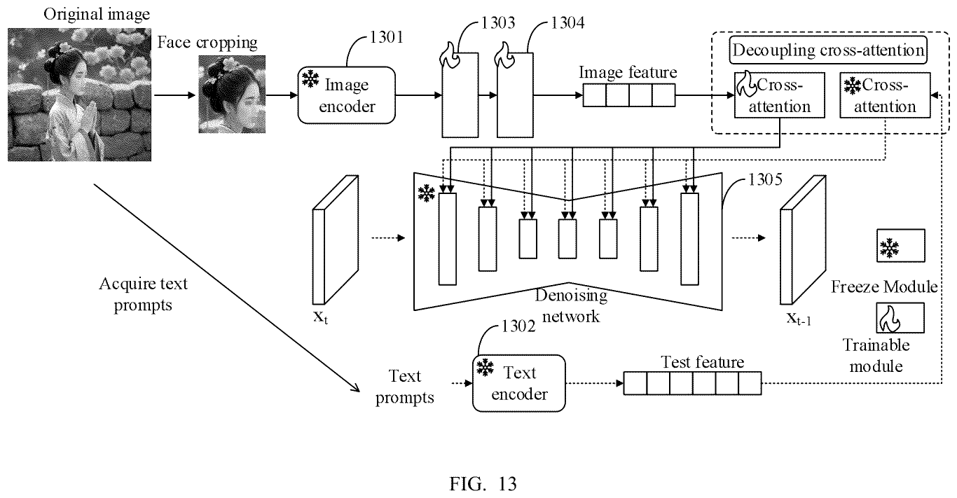

FIG. 12 is a schematic diagram of the pre-trained multi-attribute task network according to one embodiment of the present disclosure. As shown in FIG. 12, the pre-trained multi-attribute task network includes 9 tasks, which are respectively the gender, the age, the smile degree, the face image quality (image clarity), the facial attractiveness, the mask state, the glasses state, the facial key points, and the face pose (direction or angle). The weight 128*64*3*3 means that the channels thereof are 64, and there is a 3*3 convolution kennel to turn the channels from 64 into 128. The bias is equal to the weight 128. The pre-trained multi-attribute task network includes convolution layers 1201, fully connected layers 1202, and pooling layers 1203. After the original image undergoes steps of convolution, feature splitting, pooling, reshaping, concat, and inner product in the pre-trained multi-attribute task network, the facial key points, the gender, the age, the smile degree, the face image quality, the facial attractiveness, the mask state, the glasses state, and the face pose are obtained.

The face attributes are selected to reflect the age, the gender, the glasses state, the smile degree, the facial attractiveness, and the facial key points that fit the character information. The age information and the gender information are combined to form a prompt such as “boy”, “girl”, “man”, “lady”, “woman”, “old man”, “old woman”, or etc., that reflects the situation of the character (corresponding to the object attribute information in the above embodiment). The glasses state (corresponding to the wear information in the above embodiment) includes several states such as without glasses, wearing ordinary glasses, wearing sunglasses, etc., which accurately generates eye areas that match the reality. When a smile score (corresponding to the expression score in the above embodiment) is greater than 80, an additional prompt “smile” is added. When a facial attractiveness score (corresponding to the aesthetic score in the above embodiment) is greater than 80, an additional prompt “handsome” or “beautiful” is added to make the generated target object more realistic. Based on the facial key points, the opening and closing of the eyes and the opening and closing of the mouth are analyzed.

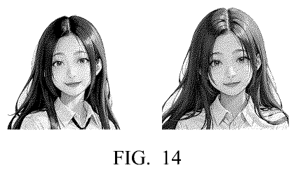

A process of obtaining the image prompts is illustrated as follows. Identity features related to the identity of the target object are extracted from the original image, and decoupled cross-modal feature fusion is performed based on the identity features and the text feature to estimate the image noise. FIG. 13 is a schematic diagram of a cross-modal network with decoupled vision and text according to one embodiment of the present disclosure. First, the original image is cropped to obtain the face image. For instance, a crop_face technology is applied to crop or extract a face area from the original image. The crop_face technology adopts a facial detection algorithm to locate the face image in the original image and then separate the face image from other parts of the original image. The feature extraction is performed on the face image by the image encoder 1301 (i. e., a facial feature extractor) to obtain the facial features (i.e., the identity features).

The image encoder 1301 is pre-trained by the resnet100 network based on the cosface loss function (i.e., the loss function based on the cosine similarity), and parameters of the image encoder 1301 are frozen when training the cross-modal network. Text prompt acquisition is performed on the original image to obtain the text prompts (for example: the prompts “one girl, solo, flower, jewelry, black hair, hair ornament, Japanese, yellow clothes, . . . ”). The text prompts further include prompts related to the anime style (for example, “anime style”). The text prompts are encoded by the text encoder 1302 to obtain the text feature. The facial features and the text feature are trained and aligned in terms of the vector dimensions by the linear layers 1303 and the layer normalization 1304 to obtain the image feature. Decoupling cross-attention refers to the decoupling of visual, textual, and generative modalities, which is divided into vision and generated cross-modality and text and generated cross-modality. The vision refers to the image feature, and the text refers to the text feature. Generation refers to the generated feature obtained by extracting features from the noise image xₜ at the t^{th} moment by the network layers in the denoising network 1305. In the denoising network 1305 (Denoising U-Net), a query matrix (Query, Q) is constructed with the generated feature in the generation process, a first key matrix (Key, K) and a first value matrix (Value, V) are constructed with the text feature, and a second key matrix K′ and a second value matrix V′ are constructed with the image feature. The calculation of the text and the generated cross-modal feature Z satisfy the above formula (1).

Attention(Q,K,V) represents the self-attention processing. Softmax represents the normalization function. d represents the vector dimensions of the query matrix Q. Q=W_{q}×xᵢ. xᵢ is the generated feature of the noise image xₜ at the t^{th} moment by the i^{th} network layer of the denoising network 1305. W_{q} is the pre-trained weight parameters in the pre-trained stable diffusion model. K=Wₖ×text feature. V=Wᵥ×text feature. Wₖ and Wᵥ are the pre-trained weight parameters.

The calculation of images and the generated cross-modal feature Z′ satisfy the above formula (2).

Where Q is equal to the query matrix Q in the calculation process of the text and the generated cross-modal feature Z.

$${K}^{′} = {W}_{k}^{′} \times the image feature . V = {W}_{v}^{′} \times the image feature . {W}_{k}^{′} and {W}_{v}^{′}$$

are trained pre-trained weight parameters.

The pre-trained weight parameters

$${W}_{k}^{′} and {W}_{v}^{′}$$

are trained according to the first loss function. The first loss function Lₛᵢₘₚₗₑ₁ satisfies the following formula (6).

$${L}_{simple 1} = {E}_{t , {x}_{0} , ε , {c}_{t} , {c}_{i}} [ {‖ ε - {ϵ}_{θ} ( {x}_{t} , {c}_{t} , {c}_{i} , t ) ‖}^{2} ] \qquad ( 6 )$$

E_{t,x}_{₀}_{,ε,c}_{ₜ}_{,c}_{ᵢ} represents the known conditions t, x₀, ε, cₜ, and cᵢ. ∈_{θ}(xₜ, cₜ, cᵢ,t) represents the t^{th} image noise. cₜ represents the text feature. cᵢ represents the image feature. Compared with the formula (3), the formula (6) adds cross-modal guidance of the text feature and the image feature. Because of the decoupling of visual and text cross-modal, the estimation of the image noise Z_{new} is more flexible. The image noise Z_{new} satisfies the following formula (7).

$${Z}_{new} = Attention ( Q , K , V ) + ω * Attention ( Q , {K}^{′} , {V}^{′} ) \qquad ( 7 )$$

ω represents the stylized weight parameter, which is flexibly adjusted according to needs of the business scenario. For instance, when the target image is more stylized, ω is adjusted lower. When the target image is more realistic in terms of character features, ω is adjusted higher. In practical applications, ω=0.4, which better balance the two. FIG. 14 is a schematic diagram of target images obtained under different stylized weight parameters according to one embodiment of the present disclosure. As shown in FIG. 14, a left figure thereof is the target image under the control effect of ω=1, and a right figure thereof is the target image under the control effect of ω=0.4.

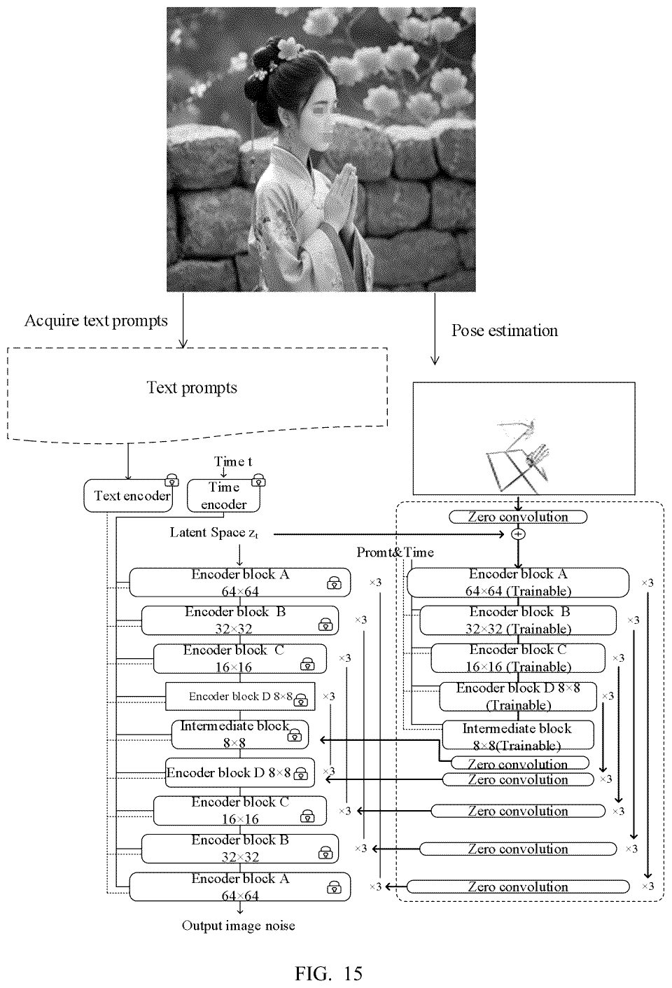

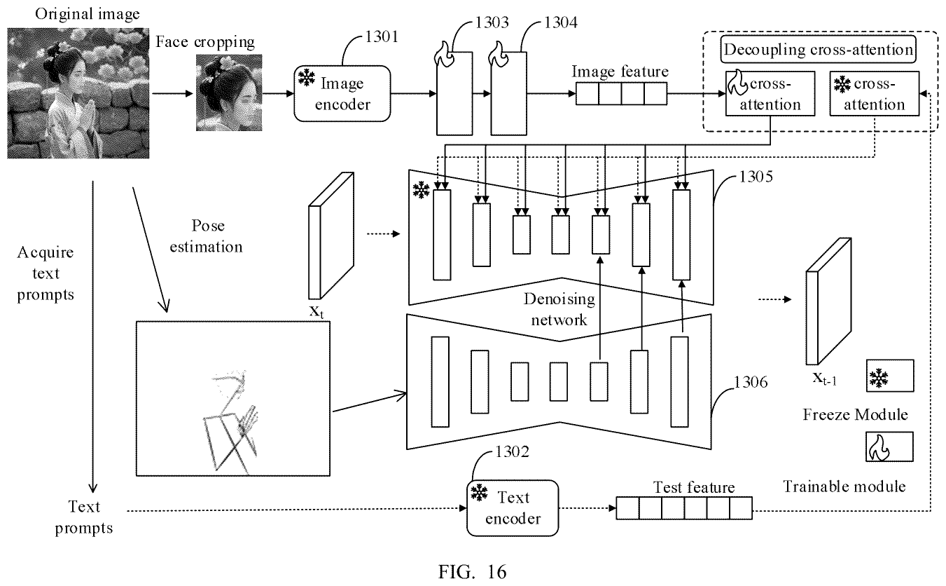

The human body pose control is described in detail below. The key points of the human body are estimated by the pose estimation technology (such as human body pose estimation technology DWPOSE), and then the key points are configured as control conditions to prompt the pose control branch network. FIG. 15 is a schematic diagram of the pose control branch network according to one embodiment of the present disclosure, where a left side thereof is a network structure of the pre-trained stable diffusion model, and a right side thereof is a network structure of the pose control branch network. Parameters of the pose control branch network are copied from that of the pre-trained stable diffusion model, which have a certain understanding ability. With training, the pose control branch network quickly combines the key point information of condition prompts with the image generation, and an image generation effect with pose control is finally obtained.

For instance, an encoder block A (SD Encoder Block A 16×16, that is, 16×16 encoder block A), an encoder block B, an encoder block C, an encoder block D and an intermediate block in the pre-trained stable diffusion model are copied to obtain the top several network layers of the pose control branch network, and the last several network layers of the pose control branch network are zero convolution. The pose control information (key points of the human body) obtained by performing human pose estimation on the original image is concatenated with the vector representations of the latent space obtained by the pre-trained stable diffusion model after zero convolution, and input into the pose control branch network. The pose feature obtained after processing each zero convolution layer in the pose control branch network is returned to corresponding decoder blocks in the pre-trained stable diffusion model. Finally, the pre-trained stable diffusion model outputs the image noise ∈_{θ}(xₜ, cₜ, cᵢ, c_{f}, t), where c_{f} represent input a pose feature (prompts of the pose control). A second loss function of the pose control branch network in FIG. 15 satisfies the following formula (8).

$${L}_{simple 2} = {E}_{t , {x}_{0} , ε , {c}_{t} , {c}_{f}} [ {‖ ε - {ϵ}_{θ} ( {x}_{t} , {c}_{t} , {c}_{f} , t ) ‖}^{2} ] \qquad ( 8 )$$

E_{t,x}_{₀}_{,ε,c}_{ₜ}_{,c}_{_{f}}_{,c}_{ᵢ} represents that t, x₀, ε, cₜ, cᵢ, and c_{f} are known. ∈_{θ}(xₜ, Cₜ, C_{f}, cᵢ, t) represents the t^{th} image noise. Compared with formula (3), formula (8) adds cross-modal guidance of the text feature and the pose feature.

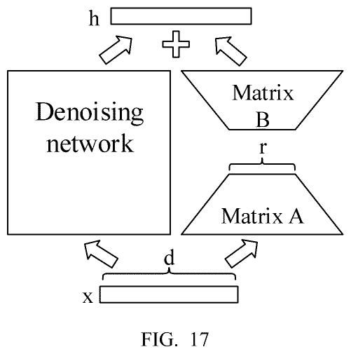

Although the pre-trained stable diffusion network is able to generate the target image in combination with scenes, object attributes, face identities, and human body pose, the target image generated at this time is still realistic and does not have strong animation stylization. In addition to adding the prompt “anime style” in the text prompts, the LoRa branch networks is further introduced to fine tune a generation style (i.e., the predetermined target style). FIG. 17 is a schematic diagram of the LoRa branch network according to one embodiment of the present disclosure. The LoRa idea is to learn and understand features in a series of images, and to be able to transfer the learning of specific artistic styles, shapes, and other features to the work. The change in parameters is simulated by low-rank decomposition, so as to realize indirect training of large models with extremely small parameter amounts. The LoRa branch network is added to the denoising network, and a first matrix A is multiplied with a second matrix B. The first matrix A is configured for dimensionality reduction, and the second matrix B is configured for dimensionality increase, and a dimension of the intermediate layer is r. The second matrix B is initialized to 0, that is, B=0, and the first matrix A is initialized to a Gaussian distribution, and A=N(0, σ²). A dimension of a trainable layer and a dimension of a pre-trained model layer are d. First, the dimension d is reduced to r through the fully connected layers, and then r is mapped back to the dimension d through the fully connected layers, where r<<d, and r is the rank of the matrices, so that the matrix calculation changes from d*d to d*r+r*d, and the number of parameters thereof is greatly reduced.

The embodiments of the present disclosure propose a method for generating an animation stylization image by integrating scene understanding, pose control, and identity preservation. By adopting the image processing method, controllable and friendly anime style images are stably generated, which brings the user a rich and interesting user experience.

It is understood that in the embodiments of the present disclosure, when the embodiments of the present disclosure are applied to specific products or technologies, related data such as user information must be obtained according to user permissions or consents, and the collection, use and processing of relevant data must comply with relevant laws, regulations, and standards.

A description of an exemplary structure of the image processing device 455 provided in the embodiment of the present DISPOSED as a software module is provided as follows. In some embodiments, as shown in FIG. 2, the software module stored in the image processing device 455 of the memory 450 includes a text prompt acquisition module 4551, a pose estimation module 4552, a noise adding module 4553, a noise generation module 4554, and an image generation module 4553.

The text prompt acquisition module 4551 is configured to recognize and analyze an original image to obtain theme elements of the original image and facial attribute information of a target object in the original image. The text prompt acquisition module is further configured to determine text prompt information based on a predetermined target style, the theme elements, and the facial attribute information. The pose estimation module 4552 is configured to perform pose estimation on the original image to obtain pose information of the target object in the original image. The noise adding module 4553 is configured to perform noise adding processing on the original image to obtain a target noise image. The noise generation module 4554 is configured to generate image noise based on the target noise image, the text prompt information, the facial attribute information of the target object in the original image, and the pose information of the target object in the original image. The image generation module 4555 is configured to generate a target image of the predetermined target style based on the image noise and the target noise image.

In some embodiments, the text prompt acquisition module 4551 is further configured to: perform scene understanding analysis on the original image based on a pre-trained visual language model to obtain the theme elements of the original image, recognize the target object in the original image to obtain a face image of the target object, and perform feature extraction on the face image based on a pre-trained multi-attribute task network to obtain the facial attribute information of the target object.

In some embodiments, the text prompt acquisition module 4551 is further configured to: encode the original image based on an image encoder in the pre-trained visual language model to obtain an image representation vector, obtain image description prompt information, encode the image description prompt information based on a text encoder in the pre-trained visual language model to obtain a prompt information feature vector, perform matching processing on the image representation vector and the prompt information feature vector to obtain a target feature vector, and decode the target feature vector based on a text decoder in the pre-trained visual language model to obtain the theme elements of the original image.

In some embodiments, the text prompt acquisition module 4551 is further configured to: perform feature extraction on the face image based on the pre-trained multi-attribute task network to obtain at least one of object attribute information, wear information, an expression score, an aesthetic score, and facial key points of the target object, and generate the facial attribute information based on at least one of the object attribute information, the wear information, the expression score, the aesthetic score, and the facial key points of the target object.

In some embodiments, the text prompt acquisition module 4551 is further configured to determine eye state information and lip state information based on the facial key points. When the expression score is greater than a predetermined first threshold, the text prompt acquisition module is further configured to obtain an expression prompt and generate the facial attribute information based on at least one of the object attribute information, the wear information, the expression prompt, the eye state information, and the lip state information. When the aesthetic score is greater than a predetermined second threshold, the text prompt acquisition module is further configured to obtain an aesthetic prompt, and generating the facial attribute information based on at least one of the object attribute information, the wear information, the aesthetic prompt, the eye state information, and the lip state information.

In some embodiments, the noise generation module 4554 is further configured to: perform feature extraction on the predetermined target style, the theme elements, and the facial attribute information to obtain text feature, and perform feature extraction on the facial attribute information in the original image to obtain an image feature; perform normalization processing on the image feature to obtain a target image feature; perform feature extraction on the pose information to obtain a pose feature; and generate the image noise based on the target noise image, the text feature, the target image feature, and the pose feature.

In some embodiments, the noise generation module 4554 is further configured to: perform self-attention processing based on the target noise image and the text feature to obtain a first attention feature; perform self-attention processing based on the target noise image and the target image feature to obtain a second attention feature; and fuse the first attention feature, the second attention feature, and the pose feature to obtain the image noise corresponding to the target noise image.

In some embodiments, the noise generation module 4554 is further configured to: fuse the first attention feature, the second attention feature, and the pose feature to obtain target noise; obtain weight parameters corresponding to the predetermined target style; and determine the image noise corresponding to the target noise image based on the target noise and the weight parameters.

In some embodiments, the image generation module 4555 is further configured to denoise the target noise image based on the image noise to obtain a (T−1)^{th}restored image, where T is an integer greater than 1. The image generation module is further configured to generate a t^{th} image noise corresponding to a t^{th} restored image based on the t^{th} restored image, the text prompt information, the facial attribute information in the original image, and the pose information. The image generation module is further configured to denoise the t^{th} restored image based on the t^{th} image noise to obtain a (t−1)^{th} restored image; where t=T−1, T−2, . . . 2. The image generation module is further configured to generate a first image noise corresponding to the first restored image based on the first restored image, the text prompt information, the facial attribute information, and the pose information, and denoising the first restored image based on the first image noise to obtain the target image of the predetermined target style.

In one optional embodiment, the image processing device 455 further comprises a video processing module. The video processing module is configured to: obtain video frame images of a video to be processed; determine target text prompt information of each of the video frame images based on the predetermined target style and each of the video frame images; perform face recognition on the video frame images to obtain target face images and perform pose estimation on the video frame images to obtain target pose information of a target object in the video frame images; perform noise adding processing on the video frame images to obtain noise video frame images, generate video frame noise based on the noise video frame images, the target text prompt information, the target face images, and the target pose information; generate the target video frame images of the predetermined target style based on the video frame noise and the noise video frame images; and arrange the target video frame images in time order to obtain a target video of the predetermined target style.

The embodiments of the present disclosure provide a computer program product. The computer program product includes a computer program or computer-executable instructions, and the computer program or the computer-executable instructions are stored in a computer-readable storage medium. The at least one processor of the electronic device reads the computer-executable instructions from the computer-readable storage medium, and the at least one processor executes the computer-executable instructions, so that the electronic device performs the image processing method of the embodiments of the present disclosure.

The embodiments of the present disclosure further provide the computer-readable storage medium. The computer-readable storage medium comprises the computer-executable instructions stored therein or the computer program stored therein. The computer-executable instructions or the computer program is executed by at least one processor to implement the image processing method according to the embodiments of the present disclosure.

In some embodiments, the computer-readable storage medium may be the memory such as the RAM, the ROM, the flash memory, a magnetic surface memory, an optical disk, a CD-ROM; or other devices including one or any combination of the above memories.

In some embodiments, the computer-executable instructions are in the form of a program, a software, a software module, a script, or codes, written in any form of programming language (including compiled or interpreted languages, or declarative or procedural languages), and are deployed in any form, including being deployed as an independent program or as a module, a component, a subroutine, or other unit suitable for use in a computing environment.

As an example, the computer-executable instructions may, but not necessarily, correspond to a file in a file system. Instead, the computer-executable instructions are stored as parts of a file storing other programs or data. For instance, the computer-executable instructions are stored in one or more scripts in a hypertext markup language (HTML) document, in a single file dedicated to the program in question, or are stored in multiple collaborative files (e.g., files storing one or more modules, subroutines, or code portions).

As an example, the computer-executable instructions are deployed to be executed on the electronic device, or on a plurality of electronic devices located at one location. Alternatively, the computer-executable instructions are executed on electronic devices disposed at multiple locations and interconnected by a communication network.

In summary, the embodiments of the present disclosure realize the stable conversion of the original image into the target image of the predetermined target style, improves the relevance of the target image to the original image, and does not require manual text input, thereby improving the accuracy and efficiency of the image stylization processing.

The above description is only optional embodiments of the present disclosure and is not intended to limit the protection scope of the present disclosure. Any modifications, equivalent substitutions, improvements, etc. made within the spirit and scope of the present disclosure are included in the protection scope of the present disclosure.

What is claimed is:

1. An image processing method, comprising steps:
recognizing and analyzing an original image to obtain theme elements of the original image and facial attribute information of a target object in the original image, and determining text prompt information based on a predetermined target style, the theme elements, and the facial attribute information;
performing pose estimation on the original image to obtain pose information of the target object in the original image;
performing noise adding processing on the original image to obtain a target noise image;
generating image noise based on the target noise image, the text prompt information, the facial attribute information of the target object in the original image, and the pose information; and
generating a target image of the predetermined target style based on the image noise and the target noise image.

2. The image processing method according to claim 1, wherein the step of recognizing and analyzing the original image to obtain the theme elements of the original image and the facial attribute information of the target object in the original image comprises steps:
performing scene understanding analysis on the original image based on a pre-trained visual language model to obtain the theme elements of the original image;
recognizing the target object in the original image to obtain a face image of the target object; and
performing feature extraction on the face image based on a pre-trained multi-attribute task network to obtain the facial attribute information of the target object.

3. The image processing method according to claim 2, wherein the step of performing scene understanding analysis on the original image based on the pre-trained visual language model to obtain the theme elements of the original image comprises steps:
encoding the original image based on an image encoder in the pre-trained visual language model to obtain an image representation vector;
obtaining image description prompt information, and encoding the image description prompt information based on a text encoder in the pre-trained visual language model to obtain a prompt information feature vector;
performing matching processing on the image representation vector and the prompt information feature vector to obtain a target feature vector; and
decoding the target feature vector based on a text decoder in the pre-trained visual language model to obtain the theme elements of the original image.

4. The image processing method according to claim 2, wherein the step of performing feature extraction on the face image based on the pre-trained multi-attribute task network to obtain the facial attribute information of the target object comprises steps:
performing feature extraction on the face image based on the pre-trained multi-attribute task network to obtain at least one of object attribute information, wear information, an expression score, an aesthetic score, and facial key points of the target object; and
generating the facial attribute information based on at least one of the object attribute information, the wear information, the expression score, the aesthetic score, and the facial key points of the target object.

5. The image processing method according to claim 4, wherein the step of generating the facial attribute information based on at least one of the object attribute information, the wear information, the expression score, the aesthetic score, and the facial key point of the target object comprises steps:
determining eye state information and lip state information based on the facial key points;
when the expression score is greater than a predetermined first threshold, obtaining an expression prompt, and generating the facial attribute information based on at least one of the object attribute information, the wear information, the expression prompt, the eye state information, and the lip state information; and
when the aesthetic score is greater than a predetermined second threshold, obtaining an aesthetic prompt, and generating the facial attribute information based on at least one of the object attribute information, the wear information, the aesthetic prompt, the eye state information, and the lip state information.

6. The image processing method according to claim 1, wherein the step of generating the image noise based on the target noise image, the text prompt information, the facial attribute information of the target object in the original image, and the pose information of the target object in the original image comprises steps:
performing feature extraction on the predetermined target style, the theme elements, and the facial attribute information to obtain a text feature, and performing feature extraction on the facial attribute information in the original image to obtain an image feature;
performing normalization processing on the image feature to obtain a target image feature;
performing feature extraction on the pose information to obtain a pose feature; and
generating the image noise based on the target noise image, the text feature, the target image feature, and the pose feature.

7. The image processing method according to claim 6, wherein the step of generating the image noise based on the target noise image, the text feature, the target image feature, and the pose feature comprises steps:
performing self-attention processing based on the target noise image and the text feature to obtain a first attention feature;
performing self-attention processing based on the target noise image and the target image feature to obtain a second attention feature; and
fusing the first attention feature, the second attention feature, and the pose feature to obtain the image noise corresponding to the target noise image.

8. The image processing method according to claim 7, wherein the steps of fusing the first attention feature, the second attention feature, and the pose feature to obtain the image noise corresponding to the target noise image comprises steps:
fusing the first attention feature, the second attention feature, and the pose feature to obtain target noise;
obtaining weight parameters corresponding to the predetermined target style; and
determining the image noise corresponding to the target noise image based on the target noise and the weight parameters.

9. The image processing method according to claim 1, wherein the step of generating the target image of the predetermined target style based on the image noise and the target noise image comprises steps:
denoising the target noise image based on the image noise to obtain a (T−1)^{th}restored image, where T is an integer greater than 1;
generating a t^{th} image noise corresponding to a t^{th} restored image based on the t^{th} restored image, the text prompt information, the facial attribute information in the original image, and the pose information;
denoising the t^{th} restored image based on the t^{th} image noise to obtain a (t−1)^{th} restored image; where t=T−1, T−2, . . . , 2; and
generating a first image noise corresponding to a first restored image based on the first restored image, the text prompt information, the facial attribute information, and the pose information, and denoising the first restored image based on the first image noise to obtain the target image of the predetermined target style.

10. The image processing method according to claim 1, wherein the image processing method further comprises steps:
obtaining video frame images in a video to be processed;
for each of the video frame images, determining target text prompt information based on the predetermined target style and each of the video frame images;
performing face recognition on the video frame images to obtain target face images, and performing pose estimation on the video frame images to obtain target pose information of a target object in each of the video frame images;
performing noise adding processing on the video frame images to obtain noise video frame images, and generating video frame noise based on the noise video frame images, the target text prompt information, the target face images, and the target pose information;
generating the target video frame images of the predetermined target style based on the video frame noise and the noise video frame images; and
arranging the target video frame images in time order to obtain a target video of the predetermined target style.

11. The image processing method according to claim 1, wherein the image processing method is executed by at least one processor, and the image processing method further comprises:
outputting the target image.

12. The image processing method according to claim 1, wherein before the step of recognizing and analyzing the original image to obtain the theme elements of the original image and the facial attribute information of the target object in the original image, the image processing method further comprises steps:
receiving an interactive operation input by a user; and
generating and sending an image processing request in response to the interactive operation.

13. The image processing method according to claim 1, wherein the step of performing noise adding processing on the original image to obtain the target noise image comprises steps:
performing, by a pre-trained stable diffusion model, one time of noise adding processing on the original image based on Gaussian noise to obtain the target noise image.

14. The image processing method according to claim 1, wherein the step of performing noise adding processing on the original image to obtain the target noise image comprises steps:
performing, by a pre-trained stable diffusion model, T times of noise adding processing on the original image based on Gaussian noise to obtain T−1 noise images, where T is an integer greater than 1; and
configuring a T^{th} noise image as the target noise image.

15. The image processing method according to claim 7, wherein the first attention feature satisfies a formula (1):
$$Z = Attention ( Q , K , V ) = Softmax ( \frac{{QK}^{T}}{\sqrt{d}} ) V ; \qquad ( 1 )$$
wherein Z represents the first attention feature, Attention represents the self-attention processing, Softmax represents a normalization function, d represents vector dimensions of the text feature, Q represents a query matrix, Q=W_{q}×xᵢ, xᵢ is a generated feature obtained by performing feature extraction on the target noise image by an i^{th} network layer of a denoising network in the pre-trained stable diffusion model, W_{q} represents first pre-trained weight parameters in the pre-trained stable diffusion model, K=Wₖ× text feature, V=Wᵥ× text feature, and Wₖ and Wᵥ are second and third pre-trained weight parameters.

16. The image processing method according to claim 15, wherein the second attention feature satisfies a formula (2):
$${Z}^{′} = Attention ( Q , {K}^{′} , {V}^{′} ) = Softmax ( \frac{{QK}^{{′}^{T}}}{\sqrt{d}} ) {V}^{′} ; \qquad ( 2 )$$
wherein Z′ represents the second attention feature,
$${K}^{′} = {W}_{k}^{′} \times the target image feature , V = {W}_{v}^{′} \times \times the target image feature , and {W}_{k}^{′} and {W}_{v}^{′}$$
are fourth and fifth pre-trained weight parameters.

17. An image processing device, comprising:
a text prompt acquisition module;
a pose estimation module;
a noise adding module;
a noise generation module; and
an image generation module;
wherein the text prompt acquisition module is configured to recognize and analyze an original image to obtain theme elements of the original image and facial attribute information of a target object in the original image, and the text prompt acquisition module is further configured to determine text prompt information based on a predetermined target style, the theme elements and the facial attribute information;
the pose estimation module is configured to perform pose estimation on the original image to obtain pose information of the target object in the original image;
the noise adding module is configured to perform noise adding processing on the original image to obtain target noise image;
the noise generation module is configured to generate image noise based on the target noise image, the text prompt information, the facial attribute information of the target object in the original image, and the pose information of the target object in the original image; and
the image generation module is configured to generate a target image of the predetermined target style based on the image noise and the target noise image.

18. An electronic device, comprising:
a memory; and
at least one processor;
wherein the memory is configured to store computer-executable instructions or a computer program, and the at least one processor is configured to execute the computer-executable instructions or the computer program stored in the memory to implement the image processing method according to claim 1.

19. A computer-readable storage medium, comprising:
computer-executable instructions stored therein; or
a computer program stored therein;
wherein the computer-executable instructions or the computer program is executed by at least one processor to implement the image processing method according to claim 1.

20. An image processing method, comprising steps:
receiving, by a terminal, and interactive operation input by a user; and
generating an image processing request, by the terminal, in response to the interactive operation;
recognizing and analyzing an original image, by the server, to obtain theme elements of the original image and facial attribute information of a target object in the original image, and determining text prompt information based on a predetermined target style, the theme elements, and the facial attribute information;
performing pose estimation on the original image by the server to obtain pose information of the target object in the original image;
performing noise adding processing on the original image, by the server, to obtain a target noise image;
generating image noise, by the server, based on the target noise image, the text prompt information, the facial attribute information of the target object in the original image, and the pose information;
generating, by the server, a target image of the predetermined target style based on the image noise and the target noise image;
sending, by the server, the target image to the terminal; and
displaying, by the terminal, the target image on a current interface of the terminal.
